(19) United States
(12) Patent Application Publication
(10) Pub. No.: US 2026/0173010 A1
(43) Pub. Date: Jun. 18, 2026

(54) USER EQUIPMENT (UE)

(71) Applicant: SHARP KABUSHIKI KAISHA, Sakai City, Osaka (JP)

(72) Inventors: SHUICHIRO CHIBA, Sakai City, Osaka (JP); YASUO SUGAWARA, Sakai City, Osaka (JP)

(21) Appl. No.: 19/144,410

(22) PCT Filed: Oct. 31, 2023
(86) PCT No.: PCT/JP2023/039224

§ 371 Date: Jun. 27, 2025

(30) Foreign Application Priority Data
Jul. 12, 2023 (JP) 2023-114181

(51) Int. Cl. H04W 60/04; H04W 48/18; H04W 88/06

(52) U.S. Cl. CPC H04W 60/04; H04W 48/18; H04W 88/06

(57) ABSTRACT

A mechanism for transmitting and/or receiving information for appropriately executing a timer based on a time offset between a UE and a network for overload control after an unavailability period in which the UE is out of coverage due to discontinuous coverage of NR satellite access and a method for performing appropriate processing based on the information are provided.

### TECHNICAL FIELD

The present invention relates to a user equipment (UE).

This application claims priority to JP 2023-114181 filed on Jul. 12, 2023, the contents of which are incorporated herein by reference.

### BACKGROUND ART

In the 3rd Generation Partnership Project (3GPP), the system architecture of a 5G System (5GS), which is a fifth generation (5G) mobile communication system, has been studied, and discussions are underway to support new procedures and new functions (see NPL 1 to NPL 4). In Release 18 of the 5G standard, an architecture for 5G communication based on artificial satellites (also simply referred to as “satellites”), a procedure for communication and control, and the like have been studied (see NPL 4).

### CITATION LIST

### Non Patent Literature

NPL 1:3GPP TS 23.501 V 18.2.2 (2023-07); 3rd Generation Partnership Project; Technical Specification Group Services and System Aspects; System Architecture for the 5G System (5GS); Stage 2 (Release 18)
NPL 2:3GPP TS 23.502 V 18.2.0 (2023-06); 3rd Generation Partnership Project; Technical Specification Group Services and System Aspects; Procedures for the 5G System (5GS); Stage 2 (Release 18)
NPL 3:3GPP TS 24.501 V 18.3.0 (2023-06); 3rd Generation Partnership Project; Technical Specification Group Core Network and Terminals; Non-Access-Stratum (NAS) Protocol for 5G System (5GS); Stage 3 (Release 18)
NPL 4:3GPP TR 23.700-28 V 18.1.0 (2023-03); 3rd Generation Partnership Project; Technical Specification Group Services and System Aspects; Study on Integration of Satellite Components in the 5G Architecture; Phase 2 (Release 18)

### SUMMARY OF INVENTION

### Technical Problem

For the 5G System (5GS), a 5G Core Network (5GCN) which is a new core network has been studied for the purpose of providing various services. Furthermore, an architecture for 5G communication based on artificial satellites (also simply referred to as “satellites”) has been studied.

Currently, for such a communication architecture that uses satellites as a radio technology (radio access technology) for connecting user equipment (UE) and core networks, studies have been conducted on extension of procedures, messages, or parameters from those in the past in consideration of characteristics of radio connection via satellites.

On the other hand, information necessary for performing control using a time offset for avoiding an overload caused by a large number of UEs simultaneously returning to the service area for new radio (NR) satellite access after an unavailability period in which the UEs are out of coverage due to discontinuous coverage via NR satellite access, transmission and/or reception of the information, and behavior and processes of the UEs and each apparatus related to overload control have not been clarified.

The present example has been made in view of the above circumstances, and an object thereof is to provide a mechanism for transmitting and/or receiving information necessary for appropriately executing a timer based on a time offset for overload control between a UE and a network after an unavailability period due to discontinuous coverage of NR satellite access, and a method for performing appropriate processing based on the information.

### Solution to Problem

A user equipment (UE) according to the present example is a UE including a transmission and/or reception unit, a controller, and, a storage unit, in which the transmission and/or reception unit is configured to receive a first timer value and/or a first type and/or a maximum wait time from a network (NW), the first timer value being a timer value indicating a duration of an unavailability period, and the first type being a type indicating that the unavailability period is not due to discontinuous coverage provided by New Radio (NR) satellite access, the controller stores the first timer value and the first type in the storage unit in association with each other, and the controller does not configure and/or start a second timer after expiration of a timer based on the first timer value associated with the first type stored in the storage unit, the second timer being a timer having a duration determined by the UE based on the maximum wait time as a timer value. A user equipment (UE) according to the present example is a UE including a transmission and/or reception unit, a controller, and a storage unit, in which the storage unit stores a first timer and a second timer, the first timer being a timer having, as a timer value, an unavailability period associated with a type indicating an unavailability period not due to discontinuous coverage provided by new radio (NR) satellite access, and the second timer being a timer having, as a timer value, an unavailability period associated with a type indicating an unavailability period due to the discontinuous coverage provided by the NR satellite access, the transmission and/or reception unit receives first control information from a network, the first control information being information indicating the first or second timer value and/or the type, and the controller executes a timer based on the first control information. A user equipment (UE) of the present example is a UE including a transmission and/or reception unit, a controller, and a storage unit, in which the storage unit stores a first timer value and a first type in association with each other, the first timer value being a timer value indicating a duration of an unavailability period, and the first type being a type indicating that the unavailability period is not due to discontinuous coverage provided by new radio (NR) satellite access, the storage unit further stores a wait time, the wait time being a value determined by the controller based on a maximum wait time received by the transmission and/or reception unit from a network, and the controller performs a Public Land Mobile Network (PLMN) selection procedure in a case that a timer based on an unavailability period due to the discontinuous coverage provided by the NR satellite access is running at a time of expiration of a timer based on the first timer value.

### Advantageous Effects of Invention

According to the present example, a mechanism for transmitting and/or receiving information necessary for a UE to appropriately execute a timer based on a time offset between a UE and a network for overload control performed after an unavailability period due to discontinuous coverage of NR satellite access and a method for the UE and the network to perform appropriate processing based on the information are provided.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the SGS.

FIG. 5 is a diagram illustrating a configuration of a core network apparatus (AMF/SMF/UPF) in the 5GS.

FIG. 6 is a diagram illustrating a registration procedure.

### DESCRIPTION OF EMBODIMENTS

Preferred embodiments for carrying out the present example will be described below with reference to the drawings. Note that an embodiment of a mobile communication system to which the present example is applied will be described as an example in the present embodiment.

### 1. Overview of System

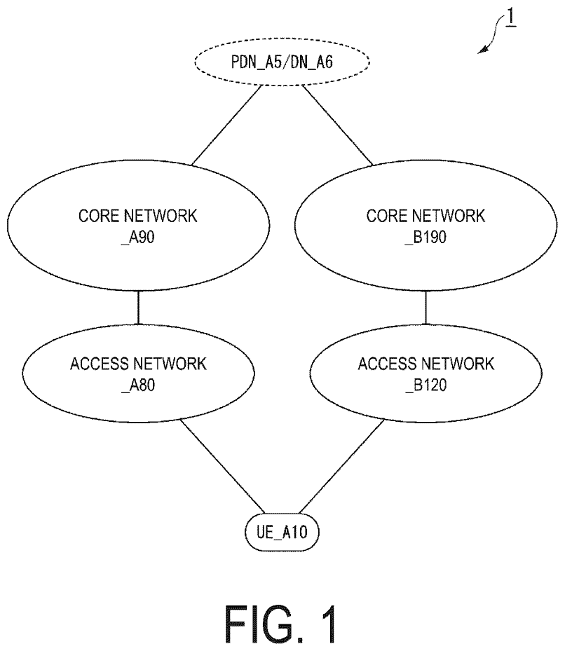

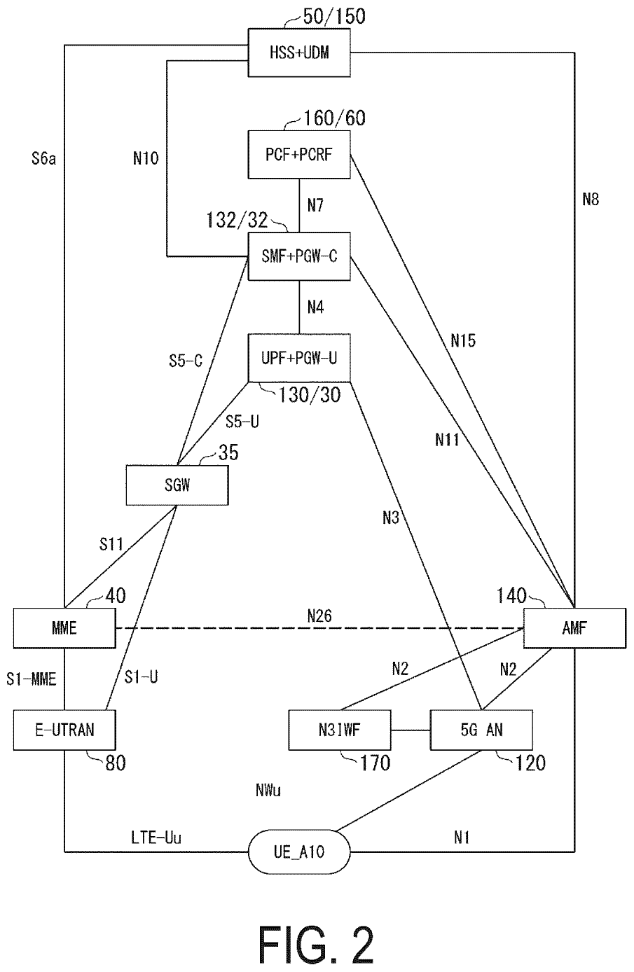

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including a UE_A 10, an access network A 80, a core network_A 90, a Packet Data Network (PDN)_A 5, an access network B 120, a core network_B 190, and a Data Network (DN)_A 6.

In the following description, the reference numerals of these apparatuses and functions may be omitted, as in a UE, an access network A, a core network A, a PDN, an access network B, a core network_B, a DN, and the like.

In addition, FIG. 2 illustrates apparatuses and functions such as the UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in a UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes the access network A and the core network_A and may further include the UE and/or the PDN. A 5G System (5GS) that is a 5G system includes the UE, the access network B, and the core network_B and may further include the DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (cUICC). Note that the UE may be referred to as user equipment or a terminal apparatus.

In addition, the access network A corresponds to an Evolved Universal Terrestrial Radio Access Network (E-UTRAN) and/or a wireless LAN access network. In the E-UTRAN, one or more evolved Node Bs (eNBs) 45 are deployed. Note that, in the following description, the reference numeral of the eNB 45 may be omitted as in eNB. In addition, in a case that there are multiple eNBs, the eNBs are connected to each other via, for example, an X2 interface. In addition, one or more access points are deployed on the wireless LAN access network.

In addition, the access network_B corresponds to a 5G access network (5G AN). The 5G AN includes an NG Radio Access Network (NG-RAN) and/or a non-3GPP access network. One or more NR NodeBs (gNBs) 122 are deployed on the NG-RAN. Note that in the following description, the symbol for the gNB 122 may be omitted as a gNB. The gNB is a node that provides a New Radio (NR) user plane and control plane to the UE, and is connected to a 5GCN via an NG interface (including an N2 interface or an N3 interface). In other words, the gNB is a base station apparatus newly designed for the 5GS and has functions different from those of the base station apparatus (eNB) used in the EPS that is a 4G system. In addition, in a case that there are multiple gNBs, the gNBs are connected to each other via, for example, an Xn interface.

In addition, a non-3GPP access network may be an untrusted non-3GPP access network or a trusted non-3GPP access network. Here, the untrusted non-3GPP access network may be a non-3GPP access network that does not manage security on the access network, for example, a public wireless LAN. On the other hand, the trusted non-3GPP access network may be an access network defined by 3GPP and may include a trusted non-3GPP access point (TNAP) and a trusted non-3GPP Gateway function (TNGF).

In addition, in the following description, the E-UTRAN and the NG-RAN may be referred to as 3GPP access. In addition, the wireless LAN access network and the non- 3GPP AN may be referred to as non-3GPP access. In addition, nodes deployed on the access network B may also be collectively referred to as NG-RAN nodes.

In addition, in the following description, the access network_A, and/or the access network B, and/or an apparatus included in the access network_A, and/or an apparatus included in the access network_B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

In addition, the core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In addition, in the following description, the core network_A, and/or the core network B, an apparatus included in the core network_A, and/or an apparatus included in the core network_B may be referred to as a core network, a core network apparatus, or an intra-core network apparatus.

The core network (the core network A and/or the core network_B) may refer to an IP mobile communication network operated by a mobile communication (Mobile Network Operator (MNO)) connecting the access network (the access network A and/or the access network B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

FIG. 1 illustrates a case that the PDN and the DN are the same; however, the PDN and the DN may be different. The PDN may be a Data Network (DN) that provides communication services to the UE. Note that the DN may be configured as a packet data service network or may be configured for each service. In addition, the PDN may include a connected communication terminal. Thus, “to be connected to the PDN” may mean “to be connected to a communication terminal and a server apparatus deployed in the PDN”. In addition, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In addition, in the following, at least some of the access network A, the core network A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network A, the core network A, the PDN, the access network_B, the core network B, and the DN, and/or one or more apparatuses included in these transmit and/or receive a message and/or perform a procedure”.

In addition, the UE can be connected to the access network. In addition, the UE can be connected to the core network over the access network. Furthermore, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using an IP, and data is transmitted and/or received using IP packets. Each IP packet includes an IP header and a payload part. In the payload part, data transmitted and/or received by the apparatuses and functions included in the EPS and the apparatuses and functions included in the 5GS may be included. In addition, non-IP communication refers to data communication performed using no IP, in which data is transmitted and/or received in a form different from the structure of an IP packet. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

In addition, apparatuses which are not illustrated in FIG. 2 may be included in the access network A, the core network A, the access network B, the core network_B, the PDN_A, and the DN_A. For example, the core network_A and/or the core network_B may include an Authentication Server Function (AUSF) and an Authentication, authorization, and accounting (AAA) server (AAA-S).

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

The AAA server is an apparatus that is connected directly to the AUSF or indirectly to the AUSF via another network apparatus and has authentication, authorization, and billing functions. The AAA server may be a network apparatus within the core network. Note that the AAA server need not be included in the core network_A and/or the core network_B and may be included in the PLMN. In other words, the AAA server may be a core network apparatus or may be an apparatus outside the core network. For example, the AAA server may be a server apparatus within the PLMN managed by a 3rd party.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

A UPF A 235 is connected to the DN, the SMF, other UPFs and the access network. The UPF_A 235 may play roles of an anchor to intra-RAT mobility or inter-RAT mobility, Packet routing & forwarding, an Uplink Classifier (UL CL) function to support routing of multiple traffic flows for one DN, a Branching point function to support a multi-homed PDU session, QoS processing for a user plane, verification of uplink traffic, buffering of downlink packets, a function of triggering Downlink Data Notification, and the like. Furthermore, the UPF_A 235 may be a relay apparatus that transfers the user data as a gateway between the DN and the core network_B 190. Note that the UPF_A 235 may serve as a gateway for IP communication and/or non-IP communication. Furthermore, the UPF_A 235 may have a function of transferring IP communication or a function to perform conversion between non-IP communication and IP communication. Furthermore, the multiple gateways deployed may serve as gateways for connecting the core network_B 190 with a single DN. Note that the UPF_A 235 may have connectivity with another NF or may be connected to each apparatus via another NF.

Note that, a UPF C 239 (also referred to as a branching point or an uplink classifier), which is a UPF different from the UPF_A 235, may be present as an apparatus or NF between the UPF A 235 and the access network. In a case that the UPF C 239 is present, the PDU session between the UE and the DN is established via the access network, the UPF C 239, and the UPF A 235.

The UPF 130 may be an apparatus similar to the UPF_A 235. Note that the UPF 130 and the UPF A 235 may be described with the symbols thereof omitted, like the UPF.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. At least a part (including all) of the functions of each apparatus may be configured as physical hardware, logical hardware, or software.

Note that each storage unit (a storage unit_A 340, a storage unit_A 440, a storage unit_B 540, a storage unit_A 640, and a storage unit_B 740) in each apparatus and function to be described later includes, for example, a semiconductor memory, a Solid State Drive (SSD), a Hard Disk Drive (HDD), or the like. In addition, each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. In addition, each storage unit can store identification information, control information, flags, parameters, and the like included in a control message transmitted and/or received in various communication procedures to be described later. In addition, each storage unit may store these pieces of information for each UE. In addition, in a case that each storage unit performs interworking between the 5GS and the EPS, each storage unit can store a control message and user data transmitted and/or received to and/or from the apparatuses and functions included in the SGS and/or the EPS. In this case, not only data transmitted and/or received over the N26 interface but also data transmitted and/or received without using the N26 interface can be stored.

### 2.1. Apparatus Configuration of UE

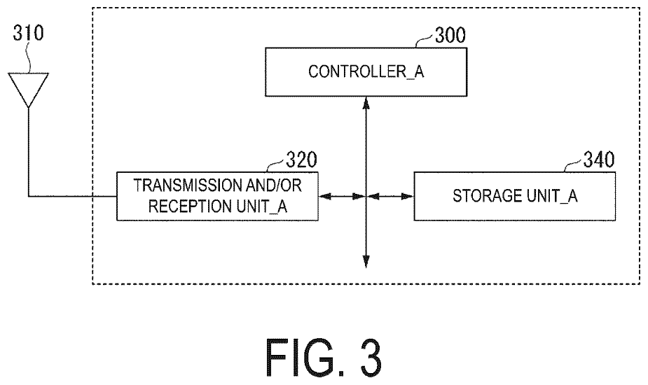

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. In addition, the UE can communicate with the base station apparatus (gNB) within the 5G AN with the use of the transmission and/or reception unit_A 320. In addition, the UE can transmit and/or receive a Non-Access-Stratum (NAS) message to and/or from the AMF over an N1 interface with the use of the transmission and/or reception unit_A 320. However, the N1 interface is a logical interface, and thus communication between the UE and the AMF is actually performed over the 5G AN.

The storage unit_A 340 is a function unit that stores programs, user data, control information, and the like necessary for each operation of the UE.

### 2.2. Apparatus Configuration of gNB

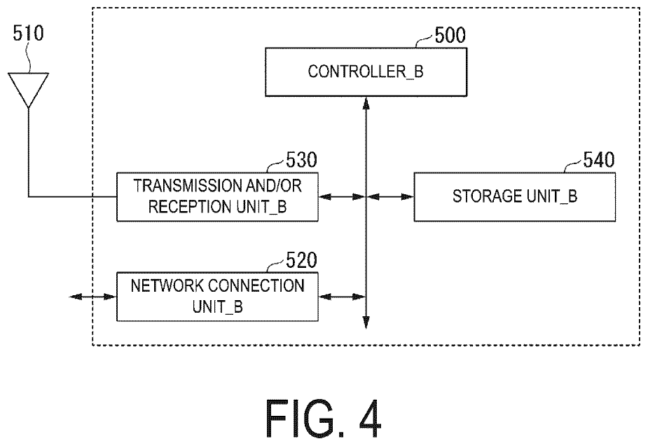

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit_B 540 are connected via a bus. The transmission and/or reception unit_B 530 is connected to the antenna 510.

The controller_B 500 is a function unit that controls overall operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit that performs radio communication with the UE via the antenna 510. In other words, with the use of the transmission and/or reception unit_B 530, the gNB can transmit and/or receive user data and/or control information to and/or from the UE.

To provide detailed description with reference to FIG. 2, by using the network connection unit_B 520, the gNB within the 5G AN can communicate with the AMF over the N2 interface and can communicate with the UPF over the N3 interface. In addition, the gNB can communicate with the UE with the use of the transmission and/or reception unit_B 530.

The storage unit_B 540 is a function unit that stores programs, user data, control information, and the like necessary for each operation of the gNB.

### 2.3. Apparatus Configuration of AMF

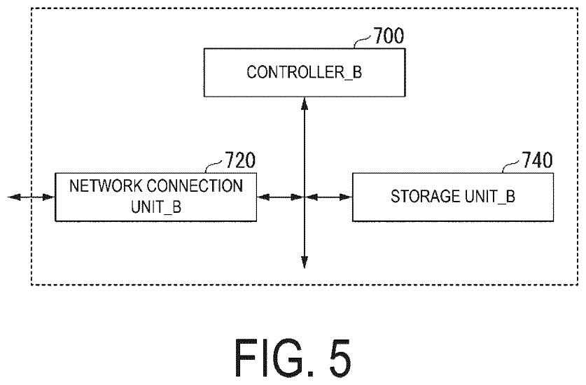

Next, an apparatus configuration example of the AMF will be described with reference to FIG. 5. The AMF includes a controller_B 700, a network connection unit_B 720, and a storage unit_B 740. The controller_B 700, the network connection unit_B 720, and the storage unit_B 740 are connected via a bus. The AMF may be a node that handles a control plane. The AMF may also be a network apparatus. In other words, for example, the network apparatus in the present specification may mean the AMF.

The controller_B 700 is a function unit that controls overall operations and functions of the AMF. The controller_B 700 reads and performs various programs stored in the storage unit_B 740 as necessary, and thereby implements various types of processing in the AMF.

The network connection unit_B 720 is a function unit for the AMF to connect to the base station apparatus (gNB) within the 5G AN, and/or the SMF, and/or the PCF, and/or the UDM, and/or an SCEF. In other words, with the use of the network connection unit_B 720, the AMF can transmit and/or receive user data and/or control information to and/or from the base station apparatus (gNB) in the 5G AN, and/or the SMF, and/or the PCF, and/or the UDM, and/or the SCEF. In other words, for example, the network connection unit may be a transmission and/or reception unit.

To provide detailed description with reference to FIG. 2, by using a network connection unit_A 620, the AMF within the 5GCN can communicate with the gNB over the N2 interface, can communicate with the UDM over an N8 interface, can communicate with the SMF over an N11 interface, and can communicate with the PCF over an N15 interface. In addition, the AMF can transmit and/or receive a NAS message to and/or from the UE over the N1 interface with the use of the network connection unit_A 620. However, the N1 interface is a logical interface, and thus communication between the UE and the AMF is actually performed over the 5G AN. In addition, in a case that the AMF supports an N26 interface, the AMF can communicate with the MME over the N26 interface with the use of the network connection unit A 620.

The storage unit_B 740 is a function unit that stores programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In addition, in registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In addition, in the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE_A 10 may start transmission and/or reception of user data and a control message, or may respond to paging. Furthermore, note that, in a case that each apparatus is in 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5GMM context, may be a state in which the location information of the UE_A 10 is not known to the network, or may be a state in which the network is unable to reach the UE_A 10. Note that, in a case that each apparatus is in 5GMM-DEREGISTERED, the UE_A 10 may initiate the registration procedure, or may perform the registration procedure to thereby establish the 5GMM context.

In addition, in connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signalling connection established with the AMF via the N1 interface. In addition, in the CM-IDLE state, the UE has neither connection of the N2 interface (N2 connection) nor connection of the N3 interface (N3 connection). On the other hand, in the CM-CONNECTED state, the UE has NAS signalling connection established with the AMF via the N1 interface. In addition, in the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access). Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non- 3GPP access may be referred to as a 5GMM non-connected mode in non-3GPP access (5GMM-IDLE mode over non-3GPP access), and the connected state in non-3GPP access may be referred to as a SGMM connected mode in non-3GPP access (5GMM-CONNECTED mode over non-3GPP access). Note that the 5GMM non-connected mode may be referred to as an idle mode, and the 5GMM connected mode may be referred to as a connected mode.

In addition, one or multiple AMFs may be deployed within the core network B. The AMF may be a Network Function (NF) that manages one or more Network Slice Instances (NSIs). In addition, the AMF may be a common CP function (Common Control Plane Network Function (CPNF)(CCNF)) shared among multiple NSIs.

Note that, in a case that the UE connects to the SGS over non-3GPP access, the N3IWF is an apparatus and/or a function deployed between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit_B 740. The controller_B 700, the network connection unit_B 720, and the storage unit_B 740 are connected via a bus. The SMF may be a node that handles the control plane.

The controller_B 700 is a function unit that controls overall operations and functions of the SMF. The controller_B 700 reads and performs various programs stored in the storage unit_B 740 as necessary, and thereby implements various types of processing in the SMF.

The network connection unit_B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM.

To provide detailed description with reference to FIG. 2, by using of the network connection unit A 620, the SMF in the 5GCN can communicate with the AMF over the N11 interface, can communicate with the UPF over the N4 interface, can communicate with the PCF over an N7 interface, and can communicate with the UDM over an N10 interface.

The storage unit_B 740 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of providing notification of arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

### 2.5. Apparatus Configuration of UPF

Next, an apparatus configuration example of the UPF will be described with reference to FIG. 5. The UPF includes a controller_B 700, a network connection unit_B 720, and a storage unit_B 740. The controller_B 700, the network connection unit_B 720, and the storage unit_B 740 are connected via a bus. The UPF may be a node that handles the control plane.

The controller_B 700 is a function unit that controls overall operations and functions of the UPF. The controller_B 700 reads and performs various programs stored in the storage unit B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN.

To provide detailed description with reference to FIG. 2, by using the network connection unit A 620, the UPF within the 5GCN can communicate with the gNB over the N3 interface, can communicate with the SMF over the N4 interface, can communicate with the DN over an N6 interface, and can communicate with another UPF over an N9 interface.

The storage unit_B 740 is a function unit that stores programs, user data, control information, and the like necessary for each operation of the UPF.

The UPF has a function as an anchor point for intra-RAT mobility or inter-RAT mobility, a function as an external PDU session point to be interconnected with the DN (that is, a function of transferring user data as a gateway between the DN and the core network B), a function of routing and transferring packets, an Uplink Classifier (UL CL) function of supporting routing of multiple traffic flows for one DN, a Branching point function of supporting a multi-homed PDU session, a Quality of Service (QOS) processing function for the user plane, a function of verifying uplink traffic, a function of triggering buffering of downlink packets and Downlink Data Notification, and the like.

In addition, the UPF may be a gateway for IP communication and/or non-IP communication. In addition, the UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

Note that a user plane refers to user data that is transmitted and/or received between the UE and a network. The user plane may be transmitted and/or received using a PDN connection or a PDU session. Furthermore, in a case of the EPS, the user plane may be transmitted and/or received using an LTE-Uu interface, and/or an S1-U interface, and/or an SS interface, and/or an S8 interface, and/or an SGi interface. Furthermore, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane.

In addition, a control plane refers to a control message that is transmitted and/or received in order to perform communication control of the UE or the like. The control plane may be transmitted and/or received using Non-Access-Stratum (NAS) signalling connection between the UE and the MME. In addition, in a case of the EPS, the control plane may be transmitted and/or received using the LTE-Uu interface and an S1-MME interface. Furthermore, in a case of the 5GS, the control plane may be transmitted and/or received using the interface between the UE and the NG RAN and the N2 interface. The control plane may be hereinafter referred to as a control plane, or may be hereinafter referred to as a C-Plane.

Furthermore, the U-Plane (User Plane (UP)) may be a communication path for transmitting and/or receiving user data, and may include multiple bearers. Furthermore, the C-Plane (Control Plane (CP)) may be a communication path for transmitting and/or receiving a control message, and may include multiple bearers.

### 2.6. Description of Other Apparatuses and/or Functions

Next, other apparatuses and/or functions will be described.

The PCF has a function such as a function of providing policy rules.

The UDM includes an authentication credential processing function, a user identification processing function, an access authentication function, a registration/mobility management function, a subscriber information management function, and the like.

The PCRF is connected to the PGW and/or the PDN and has a function such as a function of performing QoS management for data delivery. The PCRF performs, for example, QoS management for a communication path between the UE_A 10 and the PDN. The PCRF may also be an apparatus that creates and/or manages a Policy and Charging Control (PCC) rule and/or a routing rule that each apparatus uses in a case of transmitting and/or receiving user data.

The HSS is connected to the MME and/or the SCEF and has a function such as a function of managing subscriber information. The subscriber information of the HSS is referred to, for example, in a case of access control of the MME. The HSS may also be connected to a location management apparatus different from the MME.

### 3. Description of Terms and Identification Information Used in Each Embodiment

Next, terms and identification information used in each embodiment will be described in advance.

### 3.1. Description of Terms Used in Each Embodiment

Now, highly technical terms and identification information used in procedures which will be used in the embodiments will be described.

A network refers to at least some of the access network_B, the core network_B, and the DN. One or multiple apparatuses included in at least a part of the access network B, the core network B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”.

A session management (SM) message (also referred to as a Non-Access-Stratum (NAS) SM message) may be a NAS message used in a procedure for SM, or may be a control message transmitted and/or received between the UE_A 10 and the SMF A 230 via the AMF A 240.

Furthermore, the SM message may include a PDU session establishment request message, a PDU session establishment accept message, a PDU session reject message (PDU session establishment reject message), a PDU session modification request message, a PDU session modification command message, a PDU session modification completion message (PDU session modification complete), a PDU session modification command reject message, a PDU session modification reject message, a PDU session release request message, a PDU session release reject message, a PDU session release command message, a PDU session release complete message, and the like. The procedure for SM or the SM procedure may include a PDU session establishment procedure, a PDU session modification procedure, and a PDU session release procedure (UE-requested PDU session release procedure). Note that each procedure may be a procedure initiated by the UE or may be a procedure initiated by the NW.

A Mobility management (MM) message (also referred to as a NAS MM message) may be a NAS message used in a procedure for MM, or may be a control message transmitted and/or received between the UE_A 10 and the AMF A 240. Furthermore, the MM message may include a Registration request message, a Registration accept message, a Registration reject message, a De-registration request message, a De-registration accept message, a configuration update command message, a configuration update complete message, a Service request message, a Service accept message, a Service reject message, a Notification message, a Notification response message, and the like. In addition, the procedure for MM or the MM procedure may include a Registration procedure, a De-registration procedure, a Generic UE configuration update procedure (which will also be referred to simply as a “UE configuration update procedure”), an authentication and/or authorization procedure, a Service request procedure, a Paging procedure, and a Notification procedure.

A 5G System (5GS) service may be a connection service provided using the core network_B 190. In addition, the 5GS service may be a service different from an EPS service, or may be a service similar to the EPS service.

A non 5GS service may be a service other than the 5GS service and may include an EPS service and/or a non EPS service.

A Packet Data Network (PDN) type indicates a type of PDN connection and includes IPv4, TPv6, IPv4v6, and non-IP. In a case that IPv4 is specified, it indicates that transmission and/or reception of data is performed using IPv4. In a case that IPv6 is specified, it indicates that transmission and/or reception of data is performed using IPv6. In a case that IPv4v6 is specified, it indicates that transmission and/or reception of data is performed using IPv4 or IPv6. In a case that non-IP is specified, it indicates that communication is performed using a communication method other than the IP, not communication using the IP.

Although a Protocol Data Unit/Packet Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using the PDU session. Note that each apparatus (the UE, and/or the access network apparatus, and/or the core network apparatus) may associate one or multiple pieces of identification information with a PDU session for management. Note that these pieces of identification information may include one or multiple of a DNN, a QoS rule, a PDU session type, application identification information, NSI identification information, access network identification information, and an SSC mode, and may further include other pieces of information. In addition, in a case that multiple PDU sessions are established, pieces of identification information associated with the PDU sessions may have the same or different details.

The Data Network Name (DNN) may be identification information for identifying the core network and/or an external network such as the DN. Further, the DNN can also be used as information for selecting a gateway such as a PGW/UPF connecting the core network_B 190. In addition, the DNN may correspond to an Access Point Name (APN).

A Protocol Data Unit/Packet Data Unit (PDU) session type indicates a type of PDU session and includes IPv4, IPv6, Ethernet, and Unstructured. In a case that IPv4 is specified, it indicates that transmission and/or reception of data is performed using IPv4. In a case that IPv6is specified, it indicates that transmission and/or reception of data is performed using IPv6. In a case that Ethernet is specified, it indicates that transmission and/or reception of an Ethernet frame is performed. Alternatively, Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPV6.

The Public land mobile network (PLMN) is a communication network that provides mobile radio communication services. The PLMN is a network managed by an operator who is a network operator, and the operator can be identified by a PLMN ID. A PLMN that matches a Mobile Network Code (MNC) and a Mobile Country Code (MCC) of an International Mobile Subscriber Identity (IMSI) of the UE may be a Home PLMN (HPLMN). Furthermore, the UE may hold, in a USIM, an Equivalent HPLMN list (also referred to as an equivalent HPLMN) for identifying one or multiple Equivalent HPLMNs ((EPLMNs), also referred to as equivalent PLMNs). A PLMN different from the HPLMN and/or the EPLMN may be a VPLMN (Visited PLMN). A PLMN with which the UE has successfully registered may be a Registered PLMN (RPLMN).

A tracking area is a single or multiple ranges that can be expressed using location information of the UE_A 10 managed by the core network. Note that the tracking area may include multiple cells. Furthermore, the tracking area may be a range in which a control message such as paging is broadcast, or may be a range in which the UE_A 10 can move without performing a handover procedure. Furthermore, the tracking area may be a routing area, may be a location area, or may be any area similar to these. The tracking area may be hereinafter a TA. The tracking area may be identified by a Tracking Area Identity (TAI) including a Tracking area code (TAC) and a PLMN.

The Registration area is a set of one or multiple TAs allocated to the UE by the AMF. Note that, while moving within one or multiple TAs included in a registration area, the UE_A 10 may be able to move without transmitting and/or receiving a signal for updating the tracking area. In other words, the registration area may be an information group indicating an area in which the UE_A 10 can move without performing a tracking area update procedure. The registration area may be identified by a TAI list configured by one or multiple TAIs.

A current TAI is a TAI broadcast by a selected PLMN in a cell in which the UE is located or camps. In addition, in a case that the cell is a satellite NG-RAN cell that broadcasts multiple TACs in the selected PLMN, the UE NAS layer may select the current TAI from multiple tracking area codes (TACs) in the selected PLMN.

Lists of 5GS forbidden tracking areas may be lists of 5GS forbidden tracking areas for roaming and/or lists of 5GS forbidden tracking areas for regional provision of service, which are stored by the UE not operating in the SNPN access operation mode (SNPN access operation mode). In other words, the UE not operating in the SNPN access operation mode must store a list of 5GS forbidden tracking areas for roaming and/or a list of 5GS forbidden tracking areas for regional provision of service. Furthermore, the UE needs to search for a suitable cell belonging to a TA not included in the list of SGS forbidden tracking areas in the same PLMN.

Note that the UE is not allowed to request 5GS services other than emergency services in a case that the UE is in a cell of a TA that belongs to a list of 5GS forbidden tracking areas for regional provision of service.

The UE may also store the forbidden tracking area ID (TAI) in a list of 5GS forbidden tracking areas for regional provision of service to prevent repeated attempts to access cells in the forbidden tracking areas. Furthermore, the list of 5GS forbidden tracking areas for regional provision of service may be deleted in a case that the UE is powered off, a case that the SIM is removed, or deleted periodically (for a period ranging from 12 hours to 24 hours),

In addition, information indicating the 5GS forbidden tracking areas for roaming may be transmitted to the UE by being included in information elements including one or multiple forbidden TAIs (Forbidden TAI(s); also referred to as “forbidden TAIs) for the list of “SGS forbidden tracking areas for roaming” (forbidden TAI(s) for the list of “5GS forbidden tracking areas for roaming” information elements (IE)) included in a message transmitted by the network.

In addition, the 5GS forbidden tracking areas for regional provision of service may be included in information elements including one or multiple forbidden TAIs for the list of 5GS forbidden tracking areas for regional provision of service (forbidden TAI(s) for the list of “5GS forbidden tracking areas for regional provision of service” information elements (IE)) included in a message transmitted by the network and may be transmitted to the UE.

A UE ID is information for identifying the UE. The UE ID may be a Subscription Concealed Identifier (SUCI), or a Subscription Permanent Identifier (SUPI), or a Globally Unique Temporary Identifier (GUTI), or an International Mobile Subscriber Identity (IMEI), or an IMEI Software Version (IMEISV), or a Temporary Mobile Subscriber Identity (TMSI), for example. Alternatively, the UE ID may be other information configured by an application or within the network. Moreover, the UE ID may be information for identifying the user.

A non-terrestrial network (NTN) is an NG-RAN including multiple gNBs, and may provide a non-terrestrial NR access to a UE by an NTN payload and an NTN gateway mounted on an NTN transmission means such as a satellite or a flying object installed in outer space or in the air.

Here, the NTN payload is a network node that is mounted on a satellite or a high-altitude platform station and provides a function of connecting a service link and a feeder link. Furthermore, the NTN payload may be a Transport Network Layer (TNL) node.

In addition, an NTN Gateway is an earth station installed on the surface of the earth, and provides a connection to the NTN payload using a feeder link. Furthermore, the NTN gateway may be a Transport Network Layer (TNL) node,

In other words, for example, “NR connection via a satellite” (NR satellite access) by the UE may be an NR connection via a gNB including an artificial satellite (also simply referred to as a “satellite” in the present specification) with an NTN payload mounted and an NTN gateway. Furthermore, the UE may perform a procedure for registration with the network and/or establishment of a PDU session via the NR connection, and may further perform communication by using the PDU session established after completion of these procedures.

Here, in the present specification, communication via an NTN is also referred to as communication via NR satellite access, communication via an NTN, NTN communication, satellite communication, or the like. In addition, an NR connection via an NTN is also referred to as NR satellite access, or connection or access via a satellite, satellite access, satellite radio access, or the like.

A terrestrial network (TN) may provide terrestrial radio access to the UE by an access network configured by a base station installed on the ground and the like. The TN may be a terrestrial network, as opposed to the NTN, which is a non-terrestrial network using satellites. In addition, the access network installed and configured on the ground may be, for example, an NG-RAN configured with multiple gNBs, an E-UTRAN configured with multiple eNBs, or the like, but is not limited thereto.

Here, in the present specification, communication via a TN is also referred to as communication via NR terrestrial access, communication via a TN, TN communication, non-satellite communication, or the like. In addition, an NR connection via a TN is also referred to as NR terrestrial access, or connection or access via a non-satellite, non-satellite access, or the like.

A radio access technology (RAT) type of the satellite NG-RAN may be information used to identify or distinguish different types of satellite NG-RAN access in satellite NG-RAN access. In addition, the RAT type of the satellite NG-RAN may include, for example, “NR (LEO)”, “NR (MEO)”, “NR (GEO)”, and “NR (OTHERSAT)”. Here, “LEO” may mean a low earth orbit satellite, “MEO” may mean a middle earth orbit satellite, “GEO” may mean a geostationary earth orbit satellite, and “OTHERSAT” may mean other satellites.

Here, the access technology may be associated with a PLMN or an SNPN. Furthermore, a PLMN or an SNPN may be capable of supporting multiple access technologies. Here, the UE may use information of an access technology to determine the type of wireless carrier when selecting a particular PLMN or SNPN.

Also, the AMF may determine the RAT type of the NR satellite access, and in a case that the UE is accessing NR using satellite access, an indication indicating the type of NR satellite access may be provided on the N2 interface. In addition, in the serving PLMN, in order to implement efficient mobility restrictions for NR access, a TA in which a cell of each NR satellite RAT type is deployed needs to be different from a TA of another different satellite RAT type or a TA of the RAT type of terrestrial access. Further, the AMF can initiate deregistration of the UE in a case of receiving a N2 UE context release request with a cause value indicating that the UE is not in the PLMN serving area.

Here, in the present specification, communication via an NTN is also referred to as communication via NR satellite access, communication via satellite access, 5GSAT communication, NTN communication, or the like. In addition, an NR connection via a satellite (i.e., NTN) is also referred to as NR satellite access, connection or access via a satellite, satellite access, or the like. In addition, NR satellite access may be 3GPP access.

In addition, the coverage of NR satellite access provided by a satellite or satellite constellation may be discontinuous, and such a coverage is also referred to as a discontinuous network coverage, a discontinuous coverage, or an NR satellite access discontinuous coverage. Here, the discontinuous coverage may be caused by, for example, a fact that a satellite or a satellite constellation moves in time series with respect to a specific location on the earth, leading to discontinuation of the coverage that can be provided by the satellite or the satellite constellation.

In addition, it is assumed that the UE connected to the network via the NR satellite access providing such a discontinuous coverage moves back and forth between the out-of-coverage area and the in-coverage area in time series. Thus, each apparatus of the UE and/or the network may support some or all of one or multiple functions including control, parameters, or procedures for supporting discontinuous network coverage provided by NR satellite access. Note that, here, the term “in-coverage” may mean a coverage (area) in which the UE can communicate with a satellite, or may mean a coverage (area) in which the UE can communicate via a satellite. In addition, the term “out-of-coverage” may mean a coverage (area) in which the UE cannot communicate with a satellite, or may mean a coverage (area) in which the UE cannot communicate via a satellite.

More specifically, the one or multiple functions including control, parameters, or procedures for supporting a discontinuous network coverage provided by NR satellite access (NR satellite access discontinuous coverage) may include satellite coverage availability information, and/or a mobility pattern, and/or an unavailability period, and/or an unavailability period support, and/or a type of an unavailability period, and/or an unavailability period duration, and/or start of an unavailability period, and/or overload control in a discontinuous coverage provided by NR satellite access, and/or a maximum wait time for overload control in discontinuous coverage, and/or a discontinuous coverage wait timer value for overload control in a discontinuous coverage, and/or a back-off timer in a discontinuous coverage provided by the NR satellite access, and/or offset information of a timer in NR satellite access providing a discontinuous coverage, or a maximum time offset, or a discontinuous coverage maximum NAS signalling wait time. This will be described below.

Satellite coverage availability information may be location and time information related to the expected coverage availability of a satellite or a satellite constellation providing a discontinuous coverage. Here, the UE may use the satellite coverage availability information for satellite access to support discontinuous coverage operations. The satellite coverage availability information may be provided from an external server to the UE via a PDU session or a Short Message Service (SMS).

In addition, the AMF may also use the satellite coverage availability information to support satellite access by the UE in a discontinuous coverage operation. Furthermore, the satellite coverage availability information may be provided from Operation and Maintenance (O & M) to the AMF. Here, the satellite coverage availability information provided to the AMF may describe when and where satellite can be received in a certain area. Also, the satellite coverage availability information need not be UE-specific and the AMF may be applied to any UE in the affected area. In other words, the satellite coverage availability information may be information of a location or a time at which the UE is expected to be able to use satellite access provided by a satellite or a satellite constellation. That is, the satellite coverage availability information may be information indicating an expected in-coverage or out-of-coverage of the UE at the position and time indicated by the information.

In addition, the satellite coverage availability information may also include information indicating, for example, a time and a location at which each satellite is predicted to be able to provide NR satellite access to the UE on the ground. Alternatively, the satellite coverage availability information may include information indicating a time and a location at which each satellite can provide NR satellite access to the UE on the ground and a time and a location at which each satellite cannot provide NR satellite access to the UE on the ground. Note that it is needless to say that the UE on the ground is not intended to be limited to a UE that is strictly in contact with the ground surface, and includes a UE that is not in contact with the ground surface.

An unavailability period may be a period or a time in which the UE is out of coverage or is expected or assumed to be out of coverage in the NR satellite access discontinuous coverage. Furthermore, the unavailability period may be synonymous with a UE out-of-coverage period, an unreachable period (or an unreachability period), or the like. Here, the unavailability period may include an unavailability period due to the NR satellite access discontinuous coverage and an unavailability period not due to the NR satellite access discontinuous coverage. Furthermore, the unavailability period may be read as an unavailability period due to the NR satellite access discontinuous coverage and/or an unavailability period not due to the NR satellite access discontinuous coverage. Note that the unavailability period may be read as unavailability period duration.

In addition, the unavailability period not due to the NR satellite access discontinuous coverage is a period in which the network (that is, 5GS) cannot be used, for example, in units of several minutes, due to the UE performing a specific event for example, update of an OS to be performed, an update of modem firmware, or a silent reset of a modem at any timing as a specific event.

Here, since the application function cannot be used without advance notification from the NW and/or the UE due to the unavailability period not due to the NR satellite access discontinuous coverage, there is a possibility that the operation of an application server and/or the network depending on the availability of the UE during the period is affected. Therefore, the UE needs to adjust the unavailability period not due to the NR satellite access discontinuous coverage between the network and/or the application function. Note that the UE and/or the network may transmit and/or receive information on the unavailability period in order to adjust the unavailability period not due to the NR satellite access discontinuous coverage. The details thereof will be described later.

In addition, here, the unavailability period not due to the NR satellite access discontinuous coverage may be referred to as a conventional function related to the unavailability period. Note that, in the present specification, in order to distinguish from “support of the unavailability period due to the NR satellite access discontinuous coverage” described below, the above-described conventional function related to the unavailability period may be referred to as “support of the unavailability period not due to the NR satellite access discontinuous coverage”.

In addition, the unavailability period due to the NR satellite access discontinuous coverage is a period in which the UE connected to the NR satellite access providing the discontinuous coverage is out of coverage of the NR satellite access and cannot use the network (that is, 5GS), for example, in units of several minutes.

Here, by considering, for example, ephemeris information and location information of the UE as information regarding the satellite orbit, it is possible to assume in advance whether the NR satellite access can provide connectivity to the UE at a specific position on the earth. That is, the UE and/or the NW may be able to predict the unavailability period due to the NR satellite access discontinuous coverage in advance from the ephemeris information and the location information of the UE. Note that the UE may receive the ephemeris information as broadcast information from the NR satellite access and/or a control message from the network, or user data.

Here, in the unavailability period not due to the NR satellite access discontinuous coverage, it is assumed that the behavior is performed by a specific small number of UEs, and after the period, reconnection to the NW and/or resumption of communication can be performed again. On the other hand, in the unavailability period due to the NR satellite access discontinuous coverage, it is assumed that excessive unavailability occurs in the network due to reconnection in a case that a large number of UEs accommodated in the coverage of the cell provided by NR satellite access cannot be used during the period and then return to the coverage provided by the NR satellite access again. Therefore, overload control is required in consideration of a load resulting from reconnection of a large number of UEs to the NW via the NR satellite access, which is assumed after a duration of the unavailability period due to the NR satellite access discontinuous coverage. Details of overload control will be described below. In this way, depending on whether the unavailability period is due to the NR satellite access discontinuous coverage, parameters, determination, behavior, and the like considered by the UE and/or the NW may differ.

In addition, in order to realize the function of the unavailability period as described above, information indicating the type of unavailability period, and/or the unavailability period duration, and/or the start of unavailability period is required to determine whether the unavailability period is due to the NR satellite access discontinuous coverage. The information will be described below.

Unavailability period support may be capability information indicating that the function for using an unavailability period is supported. To be more specific, in the registration procedure, the UE supporting the function of the unavailability period may indicate unavailability period support as a part of capability information (5GMM Core Network Capability or 5GMM capability) in a registration request message for initial registration or all mobility registrations (or mobility registration updates).

Note that the unavailability period support may include support of the unavailability period due to the NR satellite access discontinuous coverage and support of the unavailability period not due to the NR satellite access discontinuous coverage. Details on specific operations and the like will be described below.

The information may be information indicating a type of unavailability period, information indicating whether the unavailability period is due to NR satellite access discontinuous coverage, and/or information indicating whether the unavailability period is not due to NR satellite access discontinuous coverage. In other words, for example, the type of the unavailability period may indicate that the unavailability period is due to NR satellite access discontinuous coverage.

The unavailability period duration may be information indicating a duration of the unavailability period. Furthermore, a timer may be executed using the unavailability period duration as a timer value. Here, the unavailability period duration may be information associated with the type of the unavailability period, and the UE and/or the NW may transmit or store the type of the unavailability period in association with the unavailability period duration.

A start of an unavailability period may be information indicating a timing or a time for designating a start of an unavailability period. More specifically, for example, a start of an unavailability period may be information indicating a timing or a time at which the unavailability period due to the NR satellite access discontinuous coverage is started. Note that the start of the unavailability period may be information that is not used or used in the unavailability period not due to the NR satellite access discontinuous coverage. In addition, the UE may receive and store the start of the unavailability period as broadcast information from NR satellite access and/or a message from the NW. Furthermore, the start of the unavailability period may or may not be information associated with the type of the unavailability period.

Here, a UE out-of-coverage period may be determined based on satellite coverage information and a UE mobility pattern. Note that the UE out-of-coverage period may be synonymous with an unavailability period, and the UE out-of-coverage period described in the present specification may be read as an unavailability period. Furthermore, a UE out-of-coverage period may be determined by the UE, or may be determined by a network or each network apparatus. More specifically, for example, the UE out-of-coverage period determined by the UE may be transmitted to the network, and the network or each network apparatus may receive and store the UE out-of-coverage period.

In addition, for example, the network or any network apparatus (e.g., AMF) may transmit the determined UE out-of-coverage period to the UE or the network or another network apparatus, and the UE or the network or another network apparatus may receive and store the UE out-of-coverage period. In addition, the UE out-of-coverage period is also referred to as a period in which the UE is out of coverage.

Here, the UE out-of-coverage period may be a period in which the UE is out of coverage, or may be a timer or a timer value corresponding to the period in which the UE is out of coverage. In addition, the UE out-of-coverage period may be an unreachability period, or may be a period indicated by the unreachability period or a corresponding timer or timer value. Furthermore, for example, the unreachability period may be a timer or a timer value included in an “unreachability period duration IE”. In addition, in a case that the UE out-of-coverage period is a timer or a timer value corresponding to a period in which the UE is out of coverage, the timer may be started in a case that the UE transitions to an out-of-coverage state or an idle state (idle mode).

In addition, for example, the UE may use an existing timer or a new timer different from the existing timer as the timer or the timer value corresponding to the UE out-of-coverage period. More specifically, for example, the UE out-of-coverage period may be a timer or a timer value included in a “UE out-of-coverage period duration information element (IE)”. Furthermore, the “UE out-of-coverage period duration IE” may be an existing timer or timer value (e.g., GPRS Timer 3 IE), or may be information indicating a new timer or a new timer value for 5GSAT communication. Note that, for example, in a case that the UE out-of-coverage period is an unreachability period, a timer or a timer value indicating a period corresponding to the UE out-of-coverage period may be included in the “UE out-of-coverage period duration IE” and/or the “unreachability period duration IE”,

In addition, in a case that the UE determines the UE out-of-coverage period, the UE may determine the UE out-of-coverage period based on the satellite coverage availability information and the UE mobility pattern provided from the network or the satellite coverage availability information and the UE mobility pattern held by the UE. For example, the UE may determine the UE out-of-coverage period based on satellite coverage availability information provided from the network and the UE mobility pattern provided from the network. Alternatively, for example, the UE may determine the UE out-of-coverage period based on the satellite coverage availability information provided from the network and the UE mobility pattern held by the UE. Alternatively, for example, the UE may determine the UE out-of-coverage period based on the satellite coverage availability information held by the UE and the UE mobility pattern held by the UE, while not limited thereto.

Furthermore, for example, in a case that the UE can determine the UE out-of-coverage period, and in a case that the UE determines to remain in the out-of-coverage state in a period indicated by the UE out-of-coverage period, the UE may perform a mobility registration update procedure before the start of the unreachability period. Furthermore, the UE requests a Mobile Initiated Connection Only (MICO) mode parameter, an extended DRX (eDRX) parameter in CM-IDLE, or other NAS timers taking into account the UE out-of-coverage period using the associated procedures, where the UE out-of-coverage period is not included in a case that the UE requests to use the MICO mode or eDRX. Alternatively, the UE may signal to the network the UE out-of-coverage period when the UE is about to leave the satellite coverage, and may further perform the mobility registration update procedure when the UE returns to the coverage via any access type.

The AMF may adjust the mobile reachable timer and/or the implicit deregistration timer so that the AMF does not implicitly cancel registration of the UE while the UE is in the unavailability period.

The overload control in the discontinuous coverage provided by the NR satellite access is control and/or a function for avoiding an excessive signal load on the network in a case that a large number of UEs return again to the coverage of the NR satellite access from the outside of the coverage. Furthermore, the overload control in the discontinuous coverage may be control using a maximum wait time, and/or a disco wait range, and/or a maximum time offset or a discontinuous coverage maximum NAS signalling wait time. In addition, the maximum wait time may be a time until the UE that has returned to the coverage of the satellite access is allowed to start NAS signalling with the network, which is determined by the AMF. In other words, for overload control, the AMF may determine the maximum wait time until the UE is allowed to start NAS signalling with the network. Here, the maximum wait time may be, for example, a disco wait range, and/or a maximum time offset or a discontinuous coverage maximum NAS signalling wait time, and these may be synonymous with each other in the present specification unless otherwise specified.

More specifically, for example, in overload control in discontinuous coverage using the maximum wait time, the AMF first determines the maximum wait time based on a network configuration, a priority user, or a priority service, and transmits the maximum wait time to the UE during a registration procedure or a UE configuration update procedure. Next, in a case that the UE having received the maximum wait time has already received the maximum wait time for the same RAT type and PLMN, the UE may replace the stored or saved maximum wait time.

Furthermore, the UE having received the maximum wait time may select a random value with the maximum wait time as an upper limit and determine a discontinuous coverage wait timer value. In other words, for example, in a case that the UE has stored or saved the discontinuous coverage maximum NAS signalling wait time for each PLMN and/or satellite NG-RAN RAT type, the UE may update the discontinuous coverage maximum NAS signalling wait time to the latest value in a case that the discontinuous coverage maximum NAS signalling wait time of the same PLMN and/or satellite NG-RAN RAT type combination is received.

Here, the discontinuous coverage wait timer may be a timer for restricting the UE from accessing the network through the satellite access. Furthermore, the UE may execute the discontinuous coverage wait timer based on the discontinuous coverage wait timer value determined by the UE.

In addition, in a case that the UE returns from the outside of the coverage of the NR satellite access to the inside of the coverage in the same radio access technology (RAT) type and PLMN, the UE starts the discontinuous coverage wait timer. Note that the UE executing the discontinuous coverage wait timer shall not start NAS signalling for the RAT type and PLMN.

By the above procedure and processing, a large number of UEs returning to the coverage execute the discontinuous coverage wait timer with different random values, thereby controlling and reducing an excessive signal load on the network.

Here, the maximum wait time determined by the AMF may be included in a Mobility Management (MM) message transmitted and/or received during an MM procedure and transmitted to the UE. More specifically, for example, the MM procedure in which the AMF transmits the maximum wait time to the UE may be a registration procedure or a UE configuration update procedure. Furthermore, for example, the MM message in which the AMF includes the maximum wait time may be, for example, a registration accept message, a registration reject message, or a configuration update command message. In other words, the maximum wait time may be transmitted from the AMF to the UE in an MM message in an MM procedure such as a registration procedure or a UE configuration update procedure.

In addition, in a case that the UE has stored a discontinuous coverage maximum NAS signal wait time for discontinuous coverage, if the UE is out of coverage and then gets back into the coverage of the NR satellite access, the UE configures the discontinuous coverage maximum NAS signal wait time value to a random value up to the discontinuous coverage maximum NAS signal wait time stored for the PLMN and satellite NG-RAN RAT type and starts the timer. During execution of the discontinuous coverage maximum NAS signal wait timer, the UE shall not start NAS signal on its satellite NG-RAN RAT type and PLMN.

Furthermore, in a case that the UE has received a paging message and there is an emergency service pending or the UE enters a TAI outside the registration area, the UE may stop the timer at the non-discontinuous coverage maximum NAS signalling wait time and start NAS signalling.

In addition, the UE, the network, or each apparatus using the function related to the maximum wait time may support the maximum wait time. In other words, in a case that the UE, the network, or each apparatus supports the maximum wait time, for example, the AMF may have a capability to determine the maximum wait time, or the UE may have a capability to select or determine the discontinuous coverage wait timer from the received maximum wait time. In other words, the UE, the network, or each apparatus supporting communication via the NR. satellite access may support the maximum wait time as a function for discontinuous coverage.

A back-off timer in the discontinuous coverage provided by the NR satellite access may be a timer provided by an AMF to the UE for preventing a start of mobile originated (MO) data transmission or signalling before the UE is about to go out of coverage.

In other words, the back-off timer in the satellite discontinuous coverage provided by the AMF to the UE may be a back-off timer started for the UE to end at a time when the UE is within the coverage (that is, the coverage period of the NR satellite access) based on the satellite coverage availability information, and the UE executing the timer may be prohibited from starting the transmission or signalling of MO data. In addition, in a case that the UE after the expiration of the timer is still in the same satellite communication area, the UE may start transmission or signalling of the MO data, or in a case that the UE has discovered a cell of another TN or NTN, the UE may stop the timer, get registered via a new access network, and transmit the MO data.

Note that the AMF having provided the back-off timer to the UE may initiate an AN release procedure. Furthermore, the back-off timer in the satellite discontinuous coverage may use an existing timer, or may be defined as a new timer and used.

The offset information of the timer in the NR satellite access providing discontinuous coverage may be information that is associated with a timer executed while the UE is within the coverage area or a timer executed while the UE is out of coverage area and indicates a value of a timer offset in consideration of the gap between the coverage recognized by the UE or the network based on the satellite coverage availability information and the physical coverage defined by movement of the UE, the satellite orbit, or the like. Note that, in the present specification, the offset information of the timer in the NR satellite access providing the discontinuous coverage is also referred to as offset information of a timer indicating a time or a period, timer offset information, a timer offset, offset information, simply an offset, or the like.

Here, the offset information may be information or a parameter pre-configured in the UE, determined by the UE, or determined by the network. More specifically, for example, the offset information may be information or a parameter pre-configured in the UE. Alternatively, the offset information may be information or a parameter determined by the network, transmitted to the UE, and stored by the UE after the reception. Alternatively, the offset information may be information or a parameter determined by the UE, transmitted to the network, and stored by the network or each apparatus.

In addition, timer offset information may be associated with one or multiple timers. That is, the timer offset information may be associated with the same number of pieces of offset information for each of one or more timers, or one piece of offset information may be associated with one or more timers. Here, the timer associated with the offset information may be a period or a timer indicating a time during which the UE corresponding to the satellite coverage availability information is within the coverage, and/or information associated with the UE out-of-coverage period. More specifically, for example, the offset information may be an offset value of a timer used to specify the time by which the start or end of the timer corresponding to a period in which the UE is out of or in the coverage is advanced or delayed in consideration of the discontinuous coverage in the NR satellite access. In addition, in other words, for example, in a case that the offset information is information indicating that the expiration time is extended for the timer corresponding to the UE out-of-coverage period, the UE may start the timer based on the value obtained by adding the value of the offset information to the timer value.

In addition, the UE that is connected to the network via the TN or the NTN and is in the registered state (RM-REGISTERED state) may perform a mobility registration update procedure in a case that the current TAI of the serving cell is not included in the list of TAIs received by the UE from the network, in order to maintain the registration and enable the AMF to page the UE. Note that, in the present specification, the mobility registration update procedure is also simply referred to as mobility registration update.

Furthermore, in a case that the UE is connected to the network particularly via the NTN (that is, NR satellite access), the following conditions are considered in addition to the conditions for performing the mobility registration update procedure when the UE is connected to the network via the TN or the NTN.

First, a moving radio cell for NR satellite access may be able to indicate support of one or multiple TACs for each PLMN. Here, a UE registered in a PLMN can access the radio cell and does not need to perform a mobility registration update procedure as long as at least one supported TAC of the RPLMN or an equivalent RPLMN is part of A UE registration area. In addition, the UE has to perform the mobility registration update procedure in a case of accessing a radio cell where none of the TACs supported by the RPLMN or the equivalent RPLMN is part of the UE registration area.

In addition, in a case that the UE indicates the last TAI that the UE accesses in the mobility registration update, the UE may be able to indicate a TAI that is supported in a radio cell of the RPLMN or an equivalent RPLMN that the UE last accessed before the registration update and that is part of the UE registration area.

### 3.2. Description of Identification Information in Each Embodiment

First identification information in the present example is UE capability information. The first identification information may be information included as a 5GMM capability, a 5GMM capability information element (IE), or a part of the 5GMM capability. In addition, the first identification information may be capability information of the UE indicating whether an unavailability period in consideration of NR satellite access discontinuous coverage is supported.

Here, support of the unavailability period may include support of an unavailability period due to the NR satellite access discontinuous coverage and/or support of an unavailability period not due to the NR satellite access discontinuous coverage indicated by the first identification information. In addition, the support of the unavailability period due to the NR satellite access discontinuous coverage indicated by the first identification information may indicate that an out-of-coverage period in the discontinuous coverage at the time of the NR satellite access connection can be controlled using the function of the related art (see NPL 3) related to the unavailability period. Note that, in the present specification, in order to distinguish from “support of an unavailability period due to the NR satellite access discontinuous coverage”, the above-described function of the related art related to the unavailability period may be referred to as “support of an unavailability period not due to the NR satellite access discontinuous coverage”

In addition, the first identification information may have multiple forms, and these forms are referred to as first identification information #1, and/or first identification information #2, and/or first identification information #3 in the present specification. Each of the forms of the first identification information will be described below.

First, the first identification information #1 may be capability information indicating whether the UE supports an unavailability period due to the NR satellite access discontinuous coverage. Here, the first identification information #1 may be information different from information indicating that the unavailability period not due to the NR satellite access discontinuous coverage is supported. In other words, the information indicating support of the unavailability period may include information indicating support of the unavailability period not due to the NR satellite access discontinuous coverage based on the first identification information #1 and information indicating support of the unavailability period not due to the NR satellite access discontinuous coverage.

In addition, the UE may indicate that the unavailability period due to the NR satellite access discontinuous coverage is supported by including the first identification information #1 in a message and transmitting the message to the network (NW). In addition, for example, in a case that the UE indicates to the NW that both the unavailability period due to the NR satellite access discontinuous coverage and the unavailability period not due to the NR satellite access discontinuous coverage are supported, the UE may transmit, to the NW, the first identification information #1 and information indicating support of the unavailability period not due to the NR satellite access discontinuous coverage in a message.

In addition, support of the unavailability period not due to the NR satellite access discontinuous coverage may be indicated as UN-PER bits in the 5GMM capability IE, and the first identification information #1 may be indicated as information different from the UN-PER bits in the 5GMM capability IE.

Moreover, the first identification information #2 may be capability information indicating whether the UE supports the unavailability period.

Here, for example, the first identification information #2 may be capability information indicating that the UE supports either the unavailability period due to the NR satellite access discontinuous coverage or the unavailability period not due to the NR satellite access discontinuous coverage.

Alternatively, for example, the first identification information #2 may be capability information indicating whether the UE supports the unavailability period due to the NR satellite access discontinuous coverage. In this case, for example, the UE may transmit the first identification information #2 included in a message together with third identification information indicating the type of the unavailability period due to the NR satellite access discontinuous coverage, thereby indicating to the network that the unavailability period due to the NR satellite access discontinuous coverage is supported. Furthermore, in this case, the network having received the message including the first identification information #2 together with the third identification information indicating the type of the unavailability period due to the NR satellite access discontinuous coverage from the UE may recognize that the UE supports the unavailability period due to the NR satellite access discontinuous coverage.

Conversely, for example, in a case that the UE that has included the first identification information #2 in the message does not include the third identification information indicating the type of the unavailability period due to the NR satellite access discontinuous coverage in the message, or in a case that the UE includes the third identification information indicating the type of the unavailability period not due to the NR satellite access discontinuous coverage, the UE may indicate to the NW that the UE supports the unavailability period not due to the NR satellite access discontinuous coverage. In this case, the NW having received the message may recognize that the UE supports the unavailability period not due to the NR satellite access discontinuous coverage.

In addition, for example, in a case that the UE supports the unavailability period due to the NR satellite access discontinuous coverage, the first identification information #2 may be set to indicate that the unavailability period is supported. In addition, for example, in a case that the UE supports the unavailability period not due to the NR satellite access discontinuous coverage, the first identification information #2 may be set to indicate that the unavailability period is supported.

Note that the first identification information #2 may be indicated using UN-PER bits in the SGMM capability IE.

In addition, the first identification information #3 may be capability information indicating that the UE supports the unavailability period due to the NR satellite access discontinuous coverage and/or the unavailability period not due to the NR satellite access discontinuous coverage.

In other words, for example, the first identification information #3 may be capability information indicating that the UE supports neither the unavailability period due to the NR satellite access discontinuous coverage nor the unavailability period not due to the NR satellite access discontinuous coverage. Alternatively, for example, the first identification information #3 may be capability information indicating that the UE only supports the unavailability period due to the NR satellite access discontinuous coverage. Alternatively, for example, the first identification information #3 may be capability information indicating that the UE only supports the unavailability period not due to the NR satellite access discontinuous coverage. In other words, for example, the first identification information #3 may be capability information indicating that the UE supports both the unavailability period due to the NR satellite access discontinuous coverage and the unavailability period not due to the NR satellite access discontinuous coverage.

More specifically, for example, in a case that the UE is indicated as supporting the unavailability period due to the NR satellite access discontinuous coverage, the UE may transmit the first identification information #3 indicating that the UE supports the unavailability period due to the NR satellite access discontinuous coverage to the NW in a message. In this case, the NW having received the first identification information #3 may recognize that the UE supports the unavailability period due to the NR satellite access discontinuous coverage.

Note that, in the present specification, in a case that the first identification information is simply described, the description may indicate any one of the first identification information #1, the first term information #2, or the first identification information #3. Furthermore, in a case that the term “first identification information” is simply used, it may indicate that the UE supports the NR satellite access discontinuous coverage unless otherwise specified.

In other words, in the present specification, a simple description of the first identification information may be in any form indicated by the description content related to the first identification information. More specifically, for example, the description “first identification information indicating that the UE supports the unavailability period due to the NR satellite access discontinuous coverage” may be any one of the first identification information #1 indicating that the UE supports the unavailability period due to the NR satellite access discontinuous coverage, the first identification information #2 indicating that the UE supports the unavailability period due to the NR satellite access discontinuous coverage, or the first identification information #3 indicating that at least the UE supports the unavailability period due to the NR satellite access discontinuous coverage.

In addition, details of the behavior of the UE and the NW based on the first identification information will be further described in Chapter 4 and/or Chapter 5.

Second identification information in the present example is capability information of the network (NW). The second identification information may be a 5GS network feature support or a 5GS network feature support IE or be included as part of the 5GS network feature support. In addition, the second identification information may be capability information of the NW indicating whether an unavailability period in consideration of NR satellite access discontinuous coverage is supported.

Here, support of an unavailability period may include support of an unavailability period due to the NR satellite access discontinuous coverage and/or support of an unavailability period not due to the NR satellite access discontinuous coverage indicated by the second identification information. In addition, the support of the unavailability period due to the NR satellite access discontinuous coverage indicated by the second identification information may indicate that an out-of-coverage period in the discontinuous coverage at the time of the NR satellite access connection can be controlled using the function of the related art (see NPL 3) related to the unavailability period.

Furthermore, the second identification information may have multiple forms, and these forms are referred to as second identification information #1, and/or second identification information #2, and/or second identification information #3 in the present specification. Each of the forms of the second identification information will be described below.

First, the second identification information #1 may be capability information indicating whether the NW supports an unavailability period due to the NR satellite access discontinuous coverage. Here, the second identification information #1 may be information different from information indicating that the unavailability period not due to the NR satellite access discontinuous coverage is supported. In other words, the information indicating support of the unavailability period may include information indicating support of the unavailability period not due to the NR satellite access discontinuous coverage based on the second identification information #1 and information indicating support of the unavailability period not due to the NR satellite access discontinuous coverage.

In addition, the UE may indicate that the unavailability period due to the NR satellite access discontinuous coverage is supported by including the second identification information #1 in a message and transmitting the message to a UE. In addition, for example, in a case that the NW indicates to the UE that both the unavailability period due to the NR satellite access discontinuous coverage and the unavailability period not due to the NR satellite access discontinuous coverage are supported, the NW may transmit, to the UE, the second identification information #1 and information indicating support of the unavailability period not due to the NR satellite access discontinuous coverage in a message.

In addition, the support of the unavailability period not due to the NR satellite access discontinuous coverage may be indicated as UN-PER bits in a 5GS network feature support IE, and the first identification information #1 may be indicated as information different from the UN-PER bits in the 5GS network feature support IE.

Moreover, the second identification information #2 may be capability information indicating whether the NW supports the unavailability period.

Here, for example, the second identification information #2 may be capability information indicating that the NW supports either the unavailability period due to the NR satellite access discontinuous coverage or the unavailability period not due to the NR satellite access discontinuous coverage.

Alternatively, for example, the second identification information #2 may be capability information indicating that the NW supports the unavailability period due to the NR satellite access discontinuous coverage. In this case, for example, the UE may transmit the second identification information #2 included in a message together with third identification information indicating the type of the unavailability period due to the NR satellite access discontinuous coverage, thereby indicating to the UE that the unavailability period due to the NR satellite access discontinuous coverage is supported. Furthermore, in this case, the UE having received the message including the second identification information #2 together with the third identification information indicating the type of the unavailability period due to the NR satellite access discontinuous coverage from the UE may recognize that the NW supports the unavailability period due to the NR satellite access discontinuous coverage.

Conversely, for example, in a case that the NW that has included the second identification information #2 in the message does not include the third identification information indicating the type of the unavailability period due to the NR satellite access discontinuous coverage in the message, or in a case that the NW includes the third identification information indicating the type of the unavailability period not due to the NR satellite access discontinuous coverage, the UE may indicate to the UE that the UE supports the unavailability period not due to the NR satellite access discontinuous coverage. In this case, the UE having received the message may recognize that the NW supports the unavailability period not due to the NR satellite access discontinuous coverage.

In addition, for example, in a case that the NW supports the unavailability period due to the NR satellite access discontinuous coverage, the second identification information #2 may be set to indicate that the unavailability period is supported. In addition, for example, in a case that the NW supports the unavailability period not due to the NR satellite access discontinuous coverage, the second identification information #2 may be set to indicate that the unavailability period is supported.

Note that the second identification information #2 may be indicated using UN-PER bits in a 5GS network feature support IE.

In addition, the second identification information #3 may be capability information indicating that the NW supports the unavailability period due to the NR satellite access discontinuous coverage and/or the unavailability period not due to the NR satellite access discontinuous coverage.

In other words, for example, the second identification information #3 may be capability information indicating that the NW supports neither the unavailability period due to the NR satellite access discontinuous coverage nor the unavailability period not due to the NR satellite access discontinuous coverage. Alternatively, for example, the second identification information #3 may be capability information indicating that the NW only supports the unavailability period due to the NR satellite access discontinuous coverage. Alternatively, for example, the second identification information #3 may be capability information indicating that the NW only supports the unavailability period not due to the NR satellite access discontinuous coverage. Alternatively, for example, the second identification information #3 may be capability information indicating that the NW supports both the unavailability period due to the NR satellite access discontinuous coverage and the unavailability period not due to the NR satellite access discontinuous coverage.

More specifically, for example, in a case that the NW is indicated as supporting the unavailability period due to the NR satellite access discontinuous coverage, the NW may transmit the second identification information #3 indicating that the NW supports the unavailability period due to the NR satellite access discontinuous coverage to the UE in a message. In this case, the UE having received the second identification information #3 may recognize that the NW supports the unavailability period due to the NR satellite access discontinuous coverage.

Note that, in the present specification, a simple description of the second identification information may indicate any of the second identification information #1, the second term information #2, or the second identification information #3. Furthermore, a simple description of the second identification information may indicate that the NW supports the NR satellite access discontinuous coverage unless otherwise specified.

In other words, in the present specification, a simple description of the second identification information may be in any form indicated by the description content related to the second identification information. More specifically, for example, the description “second identification information indicating that the UE supports the unavailability period due to the NR satellite access discontinuous coverage” may be any one of the second identification information #1 indicating that the UE supports the unavailability period due to the NR satellite access discontinuous coverage, the second identification information #2 indicating that the UE supports the unavailability period due to the NR satellite access discontinuous coverage, or the second identification information #3 indicating that at least the UE supports the unavailability period due to the NR satellite access discontinuous coverage.

In addition, details of the behavior of the UE and the NW based on the second identification information will be further described in Chapter 4 and/or Chapter 5.

The third identification information in the present example is information indicating the type of the unavailability period. In addition, the type of the unavailability period indicated by the third identification information may be a type indicating an unavailability period due to the NR satellite access discontinuous coverage or a type indicating an unavailability period not due to the NR satellite access discontinuous coverage. Here, the type indicated by the third identification information may be information indicating the type of the unavailability period duration and/or the start of the unavailability period transmitted in a message together with the third identification information.

In other words, for example, the third identification information may be transmitted in a message together with the unavailability period duration to indicate the type of the unavailability period or the unavailability period duration. In addition, the UE or the NW having received the third identification information, the unavailability period duration, and the start of the unavailability period may recognize that the unavailability period and the start of the unavailability period are of the type indicated by the third identification information, and the UE or the NW having received the third identification information may store the unavailability period in association with the type indicated by the third identification information.

More specifically, for example, the UE or the NW having received the third identification information indicating the type of the unavailability period due to the NR satellite access discontinuous coverage, the unavailability period duration, and/or the start of the unavailability period may store the received unavailability period duration and/or start of the unavailability period in association with the type of the unavailability period due to the NR satellite access discontinuous coverage. Furthermore, the UE or the NW may execute a timer based on the unavailability period duration as the unavailability period due to the NR satellite access discontinuous coverage, based on the start of the unavailability period.

Furthermore, the third identification information may have multiple forms, and these forms are referred to as third identification information #1, and/or third identification information #2, and/or third identification information #3 in the present specification. Each of the forms of the third identification information will be described below.

First, the third identification information #1 may be identification information indicating the type of an unavailability period due to an NR satellite access discontinuous coverage. That is, the information may mean that the unavailability period duration and/or the start of the unavailability period transmitted together with the third identification information #1 are of the type of the unavailability period due to the NR satellite access discontinuous coverage.

In other words, for example, in a case that the UE or the NW does not include the third identification information #1 in the message and transmits the unavailability period duration and/or the start of the unavailability period, these may indicate that the type of the unavailability period is not due to the NR satellite access discontinuous coverage. Furthermore, the UE or the NW having received the message may recognize that the unavailability period duration and/or the start of the unavailability period are the type of the unavailability period not due to the NR satellite access discontinuous coverage, and may store the unavailability period duration and/or the start of unavailability period in association with the type.

Here, the UE and/or the NW may indicate whether it is the type of the unavailability period due to the NR satellite access discontinuous coverage by including or not including the third identification information #1 in the message. Alternatively, the third identification information #1 may be used together with third identification information #2 described below to indicate whether the type of the unavailability period is due to the NR satellite access discontinuous coverage, and details of this case will be described below.

In addition, the third identification information #2 may be identification information indicating the type of the unavailability period not due to the NR satellite access discontinuous coverage. That is, the information may mean that the unavailability period duration and/or the start of the unavailability period transmitted together with the third identification information #2 are of the type of the unavailability period not due to the NR satellite access discontinuous coverage.

Note that the third identification information #2 may be identification information used on the premise of the above-described third identification information #1. In other words, for example, in a case that the UE or the NW indicates the type of the unavailability period due to the NR satellite access discontinuous coverage, the UE or the NW may include the third identification information #1 in a message together with the unavailability period duration and/or the start of the unavailability period. Alternatively, for example, in a case that the UE or the NW indicates the type of the unavailability period not due to the NR satellite access discontinuous coverage, the UE or the NW may include the third identification information #2 in a message together with the unavailability period duration and/or the start of the unavailability period.

In addition, the third identification information #3 may be identification information indicating the type of the unavailability period due to the NR satellite access discontinuous coverage and/or the type of the unavailability period not due to the NR satellite access discontinuous coverage. Here, the unavailability period duration and/or the start of the unavailability period may be of the type indicated by the third identification information #3.

In other words, for example, the third identification information #3 may be identification information indicating only the type of the unavailability period due to the NR satellite access discontinuous coverage. Alternatively, the third identification information #3 may be identification information indicating only the type of the unavailability period not due to the NR satellite access discontinuous coverage. Alternatively, the third identification information #3 may be identification information indicating both the type of the unavailability period due to the NR satellite access discontinuous coverage and the type of the unavailability period not due to the NR satellite access discontinuous coverage. Alternatively, the third identification information #3 may be identification information indicating neither the type of the unavailability period due to the NR satellite access discontinuous coverage nor the type of the unavailability period not due to the NR satellite access discontinuous coverage.

Note that, in a case that the third identification information is in the form of the third identification information #3, the unavailability period duration and/or the start of the unavailability period may be, for example, in a list format in which information of the corresponding type can be stored. In other words, for example, in a case that the third identification information #3 indicates both the type of the unavailability period due to the NR satellite access discontinuous coverage and the type of the unavailability period not due to the NR satellite access discontinuous coverage, the third identification information #3 may be transmitted as information in a format corresponding to each of the types.

Note that, in the present specification, the simple description of the third identification information may indicate any one of the third identification information #1, the third identification information #1 and/or the third identification information #2, or the third identification information #3. Furthermore, the simple description of the third identification information may be a type indicating the unavailability period due to NR satellite access discontinuous coverage unless otherwise specified.

In addition, details of the behavior of the UE and the network based on the third identification information will be further described in Chapter 4 and/or Chapter 5.

Details of the behavior of the UE and the network based on one or a combination of the first to third identification information are not limited to those described in this section, and are further described in Chapter 4 and/or Chapter 5.

### 4. Description of Procedure Used in Each Embodiment

Next, procedures used in each embodiment will be described. The procedures used in each embodiment herein include the registration procedure.

Note that, in each embodiment, a case that each of the HSS and the UDM, the PCF and the PCRF, the SMF and the PGW-C, and the UPF and the PGW-U is configured as a single apparatus (that is, the same physical hardware, or the same logical hardware, or the same software) as illustrated in FIG. 2 will be described as an example. However, the details described in the present embodiment can also be applied to a case that each of the combinations is configured as different apparatuses (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

Details of the registration procedure will be described below.

### 4.1. Registration Procedure

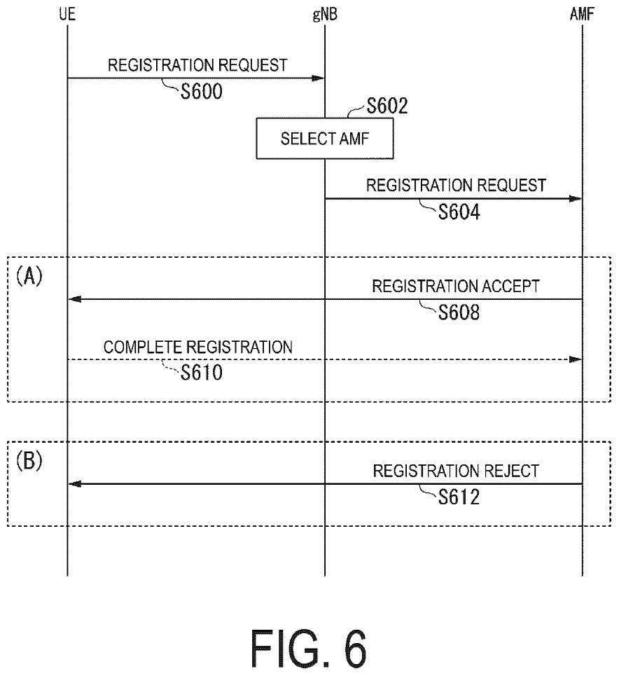

First, the registration procedure will be described with reference to FIG. 6. The registration procedure is a procedure in the SGS. Hereinafter, the registration procedure will be referred to as the present procedure in this chapter. The registration procedure is a procedure for registration with the access network_B, and/or the core network_B, and/or the DN initiated by the UE. In a case that the UE is in a state of not being registered with the network, for example, the UE can perform the present procedure at any timing, for example, a power input time. In other words, the UE can initiate the present procedure at any timing as long as the UE is in a deregistered state (an RM-DEREGISTERED state). Each of the apparatuses (especially, the UE and the AMF) can transition to a registered state (an RM-REGISTERED state) based on completion of the Registration procedure.

In addition, the registration procedure may be an initial registration, a mobility and periodic registration update, or a mobility registration update procedure initiated by the UE. Hereinafter, the mobility registration update procedure may be referred to as a registration procedure for mobility update. In addition, the registration procedure may be an MM procedure.

In addition, the registration procedure may be a procedure for updating position registration information of the UE on the network, and/or periodically provide notification of the state of the UE from the UE to the network, and/or updating a specific parameter related to the UE on the network. Alternatively, the present procedure may be a mobility registration update procedure performed to resume a normal service after the unavailability period ends after the initial registration procedure is completed.

In addition, the present procedure may be a procedure for registration by the UE via NR satellite access. In addition, a PDU session established after completion of the present procedure may be a PDU session via the satellite NG-RAN or the NR satellite access. In other words, a PDU session established through a PDU session establishment procedure performed after the registration procedure is completed through the NR satellite access may be a PDU session via the NR satellite access. Alternatively, for example, a PDU session through the NR satellite access may be established based on completion of the present procedure.

The UE may also initiate a registration procedure in a case that the UE has performed mobility across a TA. More specifically, when the UE moves to a TA different from the TA indicated on a retained TA list, the UE may initiate the mobility registration update procedure to perform re-registration. In addition, the UE may initiate the present procedure in a case that a running timer expires. In addition, the UE may initiate the registration procedure in a case that a context of each apparatus needs to be updated due to disconnection and/or invalidation of a PDU session. Furthermore, in a case that there has been a change in capability information and/or a preference, related to PDU session establishment of the UE, the UE may initiate the registration procedure. In addition, the UE may periodically initiate the registration procedure. Furthermore, the UE may also initiate a registration procedure based on completion of a UE configuration update procedure. Note that the UE is not limited to this configuration, and can perform the registration procedure at any timing.

Furthermore, the UE may also initiate the registration procedure periodically even in a registered state. In other words, the UE may initiate a registration procedure based on expiration of a timer. In other words, the registration procedure performed periodically may be a periodic registration update procedure.

Note that the registration procedure performed based on the mobility of the UE and the registration procedure performed periodically may also be expressed as a registration procedure for mobility and registration update. In other words, the registration procedure for mobility and registration update may be a registration procedure performed based on the mobility of the UE or may be a registration procedure performed periodically. Furthermore, the registration procedure for mobility and registration update may also be a registration procedure performed based on configuration update of the UE. Furthermore, the registration procedure for mobility and registration update may also be a registration procedure performed to establish a communication path for transmitting and/or receiving user data. Furthermore, the registration procedure for mobility and registration update may also be a registration procedure performed based on a request from the network. In other words, the registration procedure for mobility and registration update may be a registration procedure other than an initial registration procedure. Hereinafter, the registration procedure for mobility and registration update may be referred to as the present procedure.

Next, each step of the registration procedure will be described. The registration procedure described below may be an initial registration procedure or a registration procedure for mobility and registration update.

First, the UE initiates the registration procedure by transmitting a registration request message to the AMF (S600), (S602), and (S604). Specifically, the UE transmits an RRC message including the registration request message to the 5G AN (or the gNB) (S600). Note that the registration request message is a NAS message. The RRC message may be a control message transmitted and/or received between the UE and the 5G AN (or the gNB). In addition, the NAS message is processed in the NAS layer, and the RRC message is processed in the RRC layer. Note that the NAS layer is a layer higher than the RRC layer.

Here, the UE may transmit the first identification information, and/or the third identification information, and/or the unavailability period duration, and/or the start of the unavailability period included in the registration request message.

In addition, in a case that multiple pieces of identification information are transmitted and/or received, two or more pieces of identification information of these pieces of identification information may be configured as one or more pieces of identification information. Note that information indicating support for each function and information indicating a request to use each function may be transmitted and/or received with the same piece of identification information or may be transmitted and/or received as different pieces of identification information.

The UE may initiate the PDU session establishment procedure during the registration procedure by transmitting the registration request message including the SM message or by transmitting the SM message along with the registration request message. Here, the SM message may be a PDU session establishment request message.

In a case that the 5G AN (or the gNB) receives the RRC message including the registration request message, then the 5G AN (or the gNB) selects the AMF to transfer the registration request message (S602). Note that the 5G AN (or the gNB) can select an AMF based on information included in the registration request message and/or the RRC message. The 5G AN (or the gNB) extracts the registration request message from the received RRC message and transfers the registration request message to the selected AMF (S604).

The AMF having received the registration request message from the UE may recognize and store the content of the identification information included in the registration request message.

The AMF may perform a first condition fulfillment determination in a case that the AMF has received a registration request message. The first condition fulfillment determination is used by the network (or AMF) to determine whether to accept the request of the UE. In a case that the first condition fulfillment determination is true, the AMF initiates the procedure of (A) of FIG. 6, whereas in a case that the first condition fulfillment determination is false, the AMF initiates the procedure of (B) of FIG. 6.

Note that the first condition fulfillment determination may be performed based on reception of the registration request message, and/or each piece of identification information included in the registration request message, and/or subscriber information, and/or capability information of the network, and/or the operator policy, and/or a state of the network, and/or registration information of the user, and/or a context stored in the AMF, and/or the like. For example, the first condition fulfillment determination may be true in a case that the network allows the request from the UE, and the first condition fulfillment determination may be false in a case that the network does not allow the request from the UE. In addition, in a case that a network with which the UE is to be registered and/or an apparatus in the network supports the function requested by the UE, the first condition fulfillment determination may be true, whereas in a case that the network and/or the apparatus does not support the function requested by the UE, the first condition fulfillment determination may be false. Furthermore, in a case that the transmitted and/or received identification information is allowed, the first condition fulfillment determination may be true, whereas in a case that the transmitted and/or received identification information is not allowed, the first condition fulfillment determination may be false. Note that the conditions for determining whether the first condition fulfillment determination is true or false need not be limited to the conditions described above.

First, the case that the first condition fulfillment determination is true will be described. In the procedure of (A) of FIG. 6, first, the AMF can perform the 4th condition fulfillment determination. The fourth condition fulfillment determination is used by the AMF to determine whether to transmit and/or receive an SM message to and/or from an SMF.

The fourth condition fulfillment determination may be made based on whether the AMF has received an SM message. The fourth condition fulfillment determination may be made based on whether an SM message is included in the registration request message. For example, the fourth condition fulfillment determination may be true in a case that the AMF has received an SM message and/or in a case that an SM message is included in the registration request message and false in a case that the AMF has received no SM message and/or in a case that no SM message is included in the registration request message. The conditions for determining whether the fourth condition fulfillment determination is true or false need not be limited to the conditions described above.

Next, based on the reception of the registration request message and/or the completion of transmission and/or reception of the SM message to and/or from the SMF, the AMF transmits a registration accept message to the UE via the 5G AN (or the gNB) as a response message to the registration request message (S608). For example, in a case that the fourth condition fulfillment determination is false, the AMF may transmit a registration accept message based on receiving the registration request message from the UE. In a case where the fourth condition fulfillment determination is true, the AMF may transmit a registration accept message based on completion of transmission and/or reception of an SM messages to and/or from the SMF. Note that the registration accept message is a NAS message transmitted and/or received over the N1 interface, but is incorporated into an RRC message and transmitted and/or received between the UE and the 5G AN (the gNB).

Here, the AMF may transmit the second identification information, and/or the third identification information, and/or the unavailability period duration, and/or the start of the unavailability period included in the registration accept message.

In addition, in a case that multiple pieces of identification information are transmitted and/or received, two or more pieces of identification information of these pieces of identification information may be configured as one or more pieces of identification information. Note that information indicating support for each function and information indicating a request to use each function may be transmitted and/or received with the same piece of identification information or may be transmitted and/or received as different pieces of identification information.

Note that the AMF may select or determine whether to include, in the registration accept message, the second identification information and/or the third identification information, and/or the unavailability period duration, and/or the start of the unavailability period based on each piece of identification information, and/or subscriber information, and/or network capability information, ad/or an operator policy, and/or a network status received by the AMF from the UE or each apparatus, and/or user registration information, and/or a context held by the AMF, and/or the like.

The AMF can transmit the registration accept message including the SM message or transmit the SM message along with the registration accept message. However, this transmission method may be performed in a case that the SM message may be included in the registration request message and the fourth condition fulfillment determination is true. This transmission method may be performed in a case that the SM message is included with the registration request message and the fourth condition fulfillment determination is true. By performing such a transmission method as described above, the AMF can indicate that a procedure for SM has been accepted in the registration procedure. Here, the SM message may be a PDU session establishment request message or may be a PDU session establishment accept message.

The AMF may indicate that the request of the UE has been accepted by transmitting a registration accept message based on each piece of received identification information, subscriber information, network capability information, an operator policy, a network state, user registration information, a context held by the AMF, and/or the like.

Furthermore, the AMF may also transmit a registration accept message including information indicating that a part of the request of the UE has been rejected or may transmit information indicating that a part of the request of the UE has been rejected to indicate a reason why a part of the request of the UE has been rejected. Furthermore, the UE may also recognize a reason why a part of the request of the UE has been rejected by receiving information indicating that a part of the request of the UE has been rejected. Note that the reason for rejection may be information indicating that content indicated by the identification information received by the AMF is not allowed.

The UE receives the registration accept message from the AMF via the 5G AN (the gNB) (S608). By receiving the registration accept message, the UE can recognize that the request of the UE in the registration request message has been accepted and the content of various identification information included in the registration accept message.

Here, the UE having received the registration accept message from the AMF may recognize and store matters indicated by the received second identification information and/or third identification information, and/or unavailability period duration, and/or a start of an unavailability period, based on these pieces of information.

Furthermore, the UE can further transmit a registration complete message to the AMF via the 5G AN (gNB) as a response message to the registration accept message (S610). Here, although the registration complete message is a NAS message transmitted and/or received over the N1 interface, the registration complete message is transmitted and/or received between the UE and the 5G AN (gNB) by being included in an RRC message.

The AMF receives the registration complete message via the 5G AN (the gNB) (S610). Each apparatus completes the procedure of (A) of FIG. 6, based on transmission and/or reception of the registration accept message and/or the registration complete message.

Next, the case that the first condition fulfillment determination is false will be described. In the procedure (B) of FIG. 6, the AMF transmits a registration reject message to the UE via the 5G AN (gNB) as a response message to the registration request message (S612). Here, the registration reject message is a NAS message transmitted and/or received over the N1 interface, but is incorporated into an RRC message and transmitted and/or received between the UE and the 5G AN (the gNB).

Furthermore, the AMF may also transmit a registration reject message to indicate that the request of the UE in the registration request message has been rejected. Furthermore, the AMF may also transmit a registration reject message including information indicating a reason for rejection or may transmit a reason for rejection to indicate the reason for rejection. Furthermore, the UE may also recognize a reason why the request of the UE has been rejected by receiving information indicating the reason why the request of the UE has been rejected. Note that the reason for rejection may be information indicating that content indicated by the identification information received by the AMF is not allowed.

The UE receives the registration reject message from the AMF via the 5G AN (gNB) (S612). By receiving the registration reject message, the UE can recognize that the request of the UE in the registration request message has been rejected and the content of various identification information included in the registration reject message. The UE may also recognize that the request of the UE has been rejected in a case that the UE does not receive a registration reject message even in a case that a prescribed period of time has elapsed after transmitting a registration request message. Each apparatus completes the procedure (B) in the present procedure based on transmission and/or reception of the registration reject message.

Note that the procedure of (B) of FIG. 6 may be initiated in a case that the procedure of (A) of FIG. 6 is cancelled.

Each apparatus completes the registration procedure, based on completion of the procedure of (A) or (B) of FIG. 6. Note that each apparatus may transition to a state in which the UE is registered with the network (RM-REGISTERED state) based on the completion of the procedure of (A) of FIG. 6, may maintain a state in which the UE is not registered with the network (RM-DEREGISTERED state) or may transition to a state in which the UE is not registered with the network, based on the completion of the procedure of (B) of FIG. 6. The transition of each apparatus to each state may be performed based on completion of the registration procedure or may be performed based on establishment of a PDU session.

The UE may complete the registration procedure based on reception of the registration accept message or the registration reject message.

Furthermore, each apparatus may perform processing based on information transmitted and/or received in the registration procedure, based on completion of the registration procedure. For example, in a case that information indicating that a part of the request from the UE has been rejected is transmitted and/or received, the cause for rejection of the request from the UE may be recognized. Furthermore, each apparatus may also perform the present procedure again or may perform a registration procedure with the core network_B or another cell based on the reason why the request of the UE has been rejected.

Moreover, the UE may store the identification information received along with the registration accept message and/or the registration reject message or may recognize determination of the network based on the completion of the registration procedure.

By receiving the registration accept message or the registration reject message, the UE may recognize the content of the identification information.

A behavior to be performed in a case that each piece of identification information has been received may be performed based on the received identification information.

### 5. Embodiment

Next, each embodiment of the present example will be described. Note that each embodiment described in this chapter is based on the definitions of terms and various kinds of identification information described in Chapter 3 and the procedures described in Chapter 4.

In addition, each embodiment may be an embodiment in which the UE is connected to a network via NR satellite access and activated once registration thereof is completed.

In addition, unless otherwise specified, the embodiments in the present example are not limited to individually and independently implementing the embodiments described in each section of this chapter, and may be implemented as a combination of one or more embodiments described in each section, or one or more embodiments described in each section may be implemented in no particular order.

In addition, the UE in each embodiment may be in a state of being provided with a maximum time offset or a discontinuous coverage maximum NAS signalling wait time from the network and storing the maximum time offset or the discontinuous coverage maximum NAS signalling wait time. Here, the maximum time offset and the discontinuous coverage maximum NAS signalling wait time may be the same. Furthermore, the maximum time offset or the discontinuous coverage maximum NAS signalling wait time may be determined by the AMF. More specifically, for example, the AMF may determine a time corresponding to the maximum time offset or the discontinuous coverage maximum NAS signalling wait time or a timer value.

More specifically, for example, the AMF may provide the UE with the maximum time offset or the discontinuous coverage maximum NAS signalling wait time, included in a registration accept message transmitted and/or received during a registration procedure for initial or mobility update initiated by the UE, and/or a CONFIGURATION UPDATE COMMAND message transmitted and/or received during a UE configuration update or generic UE configuration update procedure initiated by the NW. Furthermore, the UE may store the received maximum time offset or discontinuous coverage maximum NAS signalling wait time. In addition, in a case that the UE newly receives the latest maximum time offset or discontinuous coverage maximum NAS signalling wait time, the UE may replace the maximum time offset or discontinuous coverage maximum NAS signalling wait time already received and/or stored with the latest value.

Further, the UE having received and stored the maximum time offset or the discontinuous coverage maximum NAS signalling wait time may configure a random value having the maximum time offset or the discontinuous coverage maximum NAS signalling wait time as a maximum value.

Furthermore, due to the discontinuous coverage provided by the NR satellite access, the UE having moved out of coverage and then returned into the coverage may start a timer configured to a random value with the value of the discontinuous coverage maximum NAS signalling wait time for the PLMN and the satellite NG-RAN RAT type as a maximum value.

In addition, the UE of each embodiment may receive the discontinuous coverage maximum NAS signalling wait time from the network before the start of the unavailability period and store the discontinuous coverage maximum NAS signalling wait time.

In addition, the UE and the NW of each embodiment may support the unavailability period due to the NR satellite access discontinuous coverage and the unavailability period due to the NR satellite access discontinuous coverage unless otherwise specified.

Here, the unavailability period may be read as an unavailability period due to the NR satellite access discontinuous coverage and/or an unavailability period not due to the NR satellite access discontinuous coverage.

Each embodiment of the present example will be described below.

### 5.1. First Embodiment

A first embodiment of the present example will be described Hereinafter, the first embodiment will also be referred to as the present embodiment in this section.

The UE according to the present embodiment may transmit, to the network, a registration request message including the first identification information and/or the third identification information (e.g., the third identification information #2 or #3) and/or the unavailability period duration and/or the start of the unavailability period in the registration procedure for the initial or registration update. In addition, the network having received the registration request message may transmit, to the UE, a registration accept message including the second identification information, the third identification information (e.g., the third identification information #2 or #3), and the unavailability period duration, and/or the start of the unavailability period, and/or the discontinuous coverage maximum NAS signalling wait time, and the UE may receive the registration accept message.

In addition, the UE may further receive, from the network, a message including the discontinuous coverage maximum NAS signalling wait time in a configuration update command message in the UE configuration update procedure.

More specifically, the UE according to the present embodiment, for example, the UE having received, from the network, the third identification information #2 or #3 indicating that the value of the unavailability period duration and/or the unavailability period is of the type not for the discontinuous coverage provided by the NR satellite access may simply store the unavailability period duration and/or the start of the unavailability period and the type of the unavailability period indicated by the third identification information #2 or #3, or may store the unavailability period duration and/or the start of the unavailability period in association with the type of the unavailability period. Here, the timer according to the unavailability period not due to the discontinuous coverage provided by the NR satellite access may be started or executed based on the unavailability period duration and/or the start of the unavailability period received together with the type not for the discontinuous coverage provided by the NR satellite access.

Then, the UE whose timer has expired or completed with execution need not determine the timer value based on the received discontinuous coverage maximum NAS signalling wait time, need not configure the timer value based on the discontinuous coverage maximum NAS signalling wait time, or need not start the timer value.

Here, the UE and the NW according to the present embodiment may support the unavailability period not due to the NR satellite access discontinuous coverage and the unavailability period due to the NR satellite access discontinuous coverage. Alternatively, the UE and the NW of the present embodiment may support the unavailability period not due to the NR satellite access discontinuous coverage and may not support the unavailability period due to the NR satellite access discontinuous coverage.

Note that, at the time of receiving the discontinuous coverage maximum NAS signalling wait time received, the UE may determine, and/or store, and/or configure a timer value based on the discontinuous coverage maximum NAS signalling wait time.

Alternatively, at the time of receiving the discontinuous coverage maximum NAS signalling wait time received, the UE need not determine, and/or store, and/or configure a timer value based on the discontinuous coverage maximum NAS signalling wait time. In addition, the UE may determine and/or store and/or configure a timer value based on the discontinuous coverage maximum NAS signalling wait time after the unavailability period has elapsed.

Here, these operations may be based on the UE and/or NW capability information, or may be determined based on the content of information provided and/or stored by the UE and/or the NW.

As described above, the UE according to the present embodiment receives, for example, the timer value indicating duration of the unavailability period, and/or the third identification information indicating that the unavailability period is of a type not due to the discontinuous coverage provided by NR satellite access, and/or the discontinuous coverage maximum NAS signalling wait time from the network. The UE stores the received timer value indicating a duration of the unavailability period in association with the type indicating that the timer value is not due to the discontinuous coverage provided by the NR satellite access indicated by the third identification information. The UE starts or executes the timer based on the timer value indicating a duration of the unavailability period not due to discontinuous coverage provided by NR satellite access, and after the timer expires, the UE does not configure and/or start the timer based on the discontinuous coverage maximum NAS signalling wait time.

Here, the discontinuous coverage maximum NAS signalling wait time may be a maximum value of a period or a timer indicating the discontinuous coverage maximum NAS signalling wait time received by the UE from the network. Furthermore, the UE of the present embodiment may determine and store the timer value based on, for example, the discontinuous coverage maximum NAS signalling wait time received from the network. That is, the timer based on the discontinuous coverage maximum NAS signalling wait time may be a timer in which a period determined by the UE based on the discontinuous coverage maximum NAS signalling wait time is set as a timer value. In a case that the timer based on the timer value indicating a duration of the unavailability period not due to the discontinuous coverage provided by the NR satellite access expires, the UE need not execute the timer based on the timer value determined based on the discontinuous coverage maximum NAS signalling wait time, regardless of whether the timer value determined based on the discontinuous coverage maximum NAS signalling wait time is stored.

Alternatively, for example, in a case that the timer based on the timer value indicating a duration of the unavailability period not due to the discontinuous coverage provided by the NR satellite access expires at the time of expiration of the timer based on the timer value indicating a duration of the unavailability period not due to the discontinuous coverage provided by the NR satellite access, the UE according to the present embodiment need not determine, and/or configure, and/or start the timer value based on the discontinuous coverage maximum NAS signalling wait time.

In addition, in a case that the unavailability period (or unavailability period duration) and/or a start of the unavailability period received from the network are not due to the discontinuous coverage provided by the NR satellite access, the UE may start the timer using the unavailability period (or unavailability period duration) and/or the start of the unavailability period not due to the discontinuous coverage provided by the NR satellite access, but after the timer expires (that is, after the unavailability period (or unavailability period duration) not due to the discontinuous coverage provided by the NR satellite access elapses), the UE need not configure a timer value based on the discontinuous coverage maximum NAS signalling wait time applied to the unavailability period (or unavailability period duration) due to the discontinuous coverage provided by the NR satellite access, or need not start the timer using the timer value.

In addition, in a case that the unavailability period (or unavailability period duration) and/or a start of the unavailability period received from the network are not due to the discontinuous coverage provided by the NR satellite access, the UE may start the timer using the unavailability period (or unavailability period duration) and/or the start of the unavailability period not due to the discontinuous coverage provided by the NR satellite access, but when the timer expires (that is, when the unavailability period (or unavailability period duration) not due to the discontinuous coverage provided by the NR satellite access elapses), the UE may configure a timer value based on the discontinuous coverage maximum NAS signalling wait time or may start the timer using the timer value after the unavailability period (or unavailability period duration) due to the discontinuous coverage provided by the NR satellite access elapses within the unavailability period (or unavailability period duration).

In addition, in a case that the unavailability period (or unavailability period duration) and/or a start of the unavailability period received from the network are not due to the discontinuous coverage provided by the NR satellite access, the UE may start the timer using the unavailability period (or unavailability period duration) and/or the start of the unavailability period not due to the discontinuous coverage provided by the NR satellite access, but when the timer expires (that is, when the unavailability period (or unavailability period duration) not due to the discontinuous coverage provided by the NR satellite access elapses), the UE need not configure a timer value based on the discontinuous coverage maximum NAS signalling wait time or need not start the timer using the timer value when the unavailability period (or unavailability period duration) due to the discontinuous coverage provided by the NR satellite access has elapsed.

In addition, in a case that the unavailability period (or unavailability period duration) and/or a start of the unavailability period received from the network are not due to the discontinuous coverage provided by the NR satellite access, the UE may start the timer using the unavailability period (or unavailability period duration) and/or the start of the unavailability period not due to the discontinuous coverage provided by the NR satellite access, but before the timer expires (that is, before the unavailability period (or unavailability period duration) not due to the discontinuous coverage provided by the NR satellite access elapses), the UE may stop the timer when the unavailability period (or unavailability period duration) due to the discontinuous coverage provided by the NR satellite access has started.

In addition, in a case that the unavailability period (or unavailability period duration) and/or the start of the unavailability period received from the network is due to the discontinuous coverage provided by the NR satellite access, the UE may start the timer by using the timer value configured based on the discontinuous coverage maximum NAS signalling wait time, but may stop the timer when the unavailability period (or unavailability period duration) not due to the discontinuous coverage provided by the NR satellite access has started before the timer expires.

### 5.2. Second Embodiment

Next, a second embodiment of the present example will be described. The second embodiment will also be referred to as the present embodiment in this section.

The present embodiment may include the case in which the UE and the NW support the unavailability period not due to the NR satellite access discontinuous coverage and the unavailability period due to the NR satellite access discontinuous coverage.

In addition, in a case that the UE stores a timer associated with the unavailability period not due to NR satellite access discontinuous coverage and a timer associated with the unavailability period due to NR satellite access discontinuous coverage, the UE may recognize which timer stored in the UE is to be executed, and may start or execute the timer, further based on the control information transmitted from the NW.

Here, the control information received by the UE from the NW may be information indicating either or both of a timer associated with the unavailability period not due to the NR satellite access discontinuous coverage and/or a timer associated with the unavailability period due to the NR satellite access discontinuous coverage. Furthermore, the UE having received the control information may recognize the content indicated by the control information, and start or execute the timer indicated by the control information.

More specifically, for example, in a case that the control information received by the UE from the NW includes information indicating the timer associated with the unavailability period not due to the NR satellite access discontinuous coverage, the UE may recognize that the stored timer associated with the unavailability period not due to the NR satellite access discontinuous coverage is to be executed, and may further start or execute the timer. Note that, here, the control information, which is received by the UE from the NW, indicating the timer associated with the unavailability period not due to the NR satellite access discontinuous coverage and/or the timer associated with the unavailability period due to the NR satellite access discontinuous coverage may be included in a registration accept message and/or a UE configuration command message received by the UE from the AMF, may be included in an MM message transmitted by the NW to the UE, or is not limited thereto.

More specifically, for example, in a case that the control information received by the UE from the NW includes information indicating the timer associated with the unavailability period due to the NR satellite access discontinuous coverage, the UE may recognize that the stored timer associated with the unavailability period due to the NR satellite access discontinuous coverage is to be executed, and may further start or execute the timer.

Note that, in a case that the timer executed by the UE is a timer associated with the unavailability period due to the NR satellite access discontinuous coverage, after the timer expires, the UE may further execute a timer based on the discontinuous coverage maximum NAS signalling wait time. Here, the behavior related to the timer based on the discontinuous coverage maximum NAS signalling wait time may be the behavior described in a fourth embodiment.

Here, for example, the control information transmitted by the NW to the UE may be determined in consideration of the magnitude of timer values from the timer associated with the unavailability period not due to the NR satellite access discontinuous coverage and the timer associated with the unavailability period due to the NR satellite access discontinuous coverage. For example, a timer having a larger timer value may be selected and determined.

Alternatively, for example, the control information transmitted by the NW to the UE may be determined by selecting a timer with a later timer expiration time from the timer associated with the unavailability period not due to the NR satellite access discontinuous coverage and the timer associated with the unavailability period due to the NR satellite access discontinuous coverage.

Alternatively, for example, the control information transmitted by the NW to the UE may be determined by selecting a timer value from the timer associated with the unavailability period not due to the NR satellite access discontinuous coverage and the timer associated with the unavailability period due to the NR satellite access discontinuous coverage based on the UE policy and/or the network policy.

Note that “storing the timer” may mean storing a timer value in association with each timer.

The UE of the present embodiment stores, for example, the timer associated with the unavailability period not due to NR satellite access discontinuous coverage and the timer associated with the unavailability period due to the NR satellite access discontinuous coverage. Furthermore, the UE storing these timers may recognize and/or determine which timer stored in the UE is to be executed based on the control information received from the NW, and may start or execute the timer. Here, the control information received by the UE from the network may be information indicating either or both of the timer associated with the unavailability period not due to the NR satellite access discontinuous coverage and/or the timer associated with the unavailability period due to the NR satellite access discontinuous coverage. Furthermore, the UE having received the control information may recognize the content indicated by the control information, and start or execute the timer indicated by the control information.

### 5.3. Third Embodiment

Next, a third embodiment of the present example will be described. The third embodiment will also be referred to as the present embodiment in this section.

The UE of the present embodiment may store a timer value determined based on a timer based on the discontinuous coverage maximum NAS signalling wait time in addition to the timer associated with the unavailability period not due to the NR satellite access discontinuous coverage and/or the timer associated with the unavailability period due to the NR satellite access discontinuous coverage, and may further start or execute the timer associated with the unavailability period not due to the NR satellite access discontinuous coverage.

Subsequently, in a case that the UE is out of coverage because of the duration of the unavailability period due to the NR satellite access discontinuous coverage when the timer has expired, the UE may perform the PLMN selection procedure and/or RAT selection.

Alternatively, in a case that the timer associated with the unavailability period due to the NR satellite access discontinuous coverage has not expired when the timer expired, the UE may perform the PLMN selection procedure and/or RAT selection. Here, in a case that the timer associated with the unavailability period due to the NR satellite access discontinuous coverage has not expired when the timer expired, the UE may be out of coverage of the NR satellite access.

Alternatively, the UE of the present embodiment stores, for example, the timer associated with the unavailability period not due to the NR satellite access discontinuous coverage. Furthermore, the UE may store a timer value determined by the UE based on the timer based on the discontinuous coverage maximum NAS signalling wait time. The UE may perform the PLMN selection procedure in a case that the stored timer associated with the unavailability period due to the satellite access discontinuous coverage is running after the expiration of the stored timer associated with the unavailability period not due to the NR satellite access discontinuous coverage. Note that the PLMN selection procedure may be to select different PLMN/access technology combinations in which the UE attempts to register. For example, the UE may select a PLMN/access technology combination from a list of PLMN IDs and access technologies (PLMN ID and access technology list) stored by the UE, in consideration of the PLMN and/or the access technologies. Here, such an access technology may be read as a radio access technology, radio access, or an access network. Furthermore, the access technology may include radio access via a TN or radio access via an NTN.

### 5.4. Fourth Embodiment

Next, a fourth embodiment of the present example will be described. The fourth embodiment will also be referred to as the present embodiment in this section. The present embodiment relates to processing of a timer based on a discontinuous coverage maximum NAS signalling wait time. In addition, the present embodiment may be of behavior performed by the UE and/or the NW in each of the first to third embodiments.

The present embodiment may include the case in which the UE and/or the NW support both the unavailability period due to the NR satellite access discontinuous coverage and the unavailability period not due to the NR satellite access discontinuous coverage.

Furthermore, the UE and/or the NW may receive and store both the unavailability period not due to the NR satellite access discontinuous coverage and the unavailability period duration due to the NR satellite access discontinuous coverage in the registration procedure and/or the UE configuration update procedure. Here, the unavailability period not due to the NR satellite access discontinuous coverage may be in a state of being stored in association with the type not due to the NR satellite access discontinuous coverage indicated by the third identification information transmitted and/or received together with the unavailability period.

In a case that the unavailability period due to the NR satellite access discontinuous coverage expires during the execution of the unavailability period not due to the NR satellite access discontinuous coverage started at any timing, the UE according to the present embodiment may determine, configure, and execute the timer value based on the discontinuous coverage maximum NAS signalling wait time, or need not perform these operations.

More specifically, for example, in a case that both the UE and the NW support at least the unavailability period due to the NR satellite access discontinuous coverage and in a case that the third identification information indicating the type of the unavailability period due to the NR satellite access discontinuous coverage and the unavailability period duration have been received from the network, the UE may determine, store, or configure the timer value based on the discontinuous coverage maximum NAS signalling wait time at the timing at which the timer based on the discontinuous coverage maximum NAS signalling wait time is received.

Alternatively, for example, in a case that both the UE and the NW support at least the unavailability period due to the NR satellite access discontinuous coverage and in a case that the third identification information indicating the type of the unavailability period due to the NR satellite access discontinuous coverage and the unavailability period duration have been received from the network, the UE may determine, store, or configure the timer value based on the discontinuous coverage maximum NAS signalling wait time after the timer based on the discontinuous coverage maximum NAS signalling wait time is received and after the expiration of the unavailability period.

Alternatively, for example, in a case that both the UE and the NW support at least the unavailability period due to the NR satellite access discontinuous coverage and in a case that the third identification information indicating the type of the unavailability period due to the NR satellite access discontinuous coverage and the unavailability period duration have not received from the network, the UE need not determine, and/or store, and/or configure, and/or start the timer value based on the discontinuous coverage maximum NAS signalling wait time after the timer based on the discontinuous coverage maximum NAS signalling wait time is received.

### 6. Modifications

A program running on an apparatus according to the present example may serve as a program that controls a central processing unit (CPU) and the like to cause a computer to function to realize the functions of the aforementioned embodiments according to the present example. Programs or information handled by the programs are temporarily stored in a volatile memory such as a random access memory (RAM), a non-volatile memory such as a flash memory, a hard disk drive (HDD), or another storage apparatus system.

Note that a program for realizing the functions of the embodiments according to the present example may be recorded on a computer-readable recording medium. The functions may be realized by causing a computer system to read the program recorded on the recording medium for execution. It is assumed that the “computer system” refers to a computer system built into the apparatuses, and the computer system includes an operating system and hardware components such as a peripheral device. In addition, the “computer-readable recording medium” may be a semiconductor recording medium, an optical recording medium, a magnetic recording medium, a medium dynamically retaining the program for a short time, or any other computer-readable recording medium.

In addition, each functional block or various features of the apparatuses used in the aforementioned embodiments may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. In addition, in a case that a circuit integration technology that replaces the current integrated circuits appears with advances in semiconductor technologies, one or multiple aspects of the present example can also use a new integrated circuit based on the technology.

Note that the present example is not limited to the above-described embodiments. Although apparatuses have been described as an example in the embodiments, the present example is not limited thereto, and is applicable to a terminal apparatus or a communication apparatus for a fixed-type or a non-stationary electronic apparatus installed indoors or outdoors, for example, an AV apparatus, a kitchen apparatus, a cleaning or washing machine, an air-conditioning apparatus, office equipment, a vending machine, and other household apparatuses.

Although the embodiments of the present example have been described in detail above referring to the drawings, the specific configurations are not limited to those embodiments and include, for example, design changes within the scope that do not depart from the gist of the present embodiment. Furthermore, various modifications are possible within the scope of the present example defined by claims, and embodiments that are made by suitably combining technical means disclosed according to the different embodiments are also included in the technical scope of the present example. In addition, a configuration in which elements described in the respective embodiments and having mutually similar effects are substituted for one another is also included.

### Industrial Applicability

The present example can be utilized, for example, in a communication system, communication equipment (for example, a cellular phone apparatus, a base station apparatus, a wireless LAN apparatus, or a sensor device), an integrated circuit (for example, a communication chip), or a program.

### Reference Signs List

1 Mobile communication system
10 UE_A
30 PGW-U
32 PGW-C
35 SGW
40 MME
45 eNB
50 HSS
60 PCRF
80 Access network A (E-UTRAN)
90 Core network A
120 Access network_B (5G AN)
122 gNB
130 UPF
132 SMF
140 AMF
150 UDM
160 PCF
190 Core network B
235 UPF A
239 UPF C

1.-4. (canceled)

5. An Access and Mobility Management Function (AMF) comprising:
a controller; and
transmission and reception circuitry, wherein
the transmission and reception circuitry is configured to receive, from a User Equipment (UE), a registration request message including capability information of the UE, an unavailability period duration, a start of an unavailability period, and a type of unavailability,
in a case that the capability information of the UE indicates that an unavailability period is supported, the controller is configured to include capability information of a network indicating that the unavailability period is support, in a registration accept message,
in a case that the type of unavailability indicates an unavailability due to a discontinuous coverage, the controller is configured to include an unavailability period duration and a start of an unavailability period in the registration accept message, and
the transmission and reception circuitry is configured to transmit, to the UE, the registration accept message.

6. A User Equipment (UE) comprising:
transmission and reception circuitry, wherein
the transmission and reception circuitry is configured to transmit, to a network, a registration request message including capability information of the UE, an unavailability period duration, a start of an unavailability period, and a type of unavailability,
in a case that the capability information of the UE indicates that an unavailability period is supported, the transmission and reception circuitry is configured to receive, from the network, a registration accept message including capability information of a network indicating that the unavailability period is supported, and
in a case that the type of unavailability indicates an unavailability due to a discontinuous coverage, the registration accept message include an unavailability period duration and a start of an unavailability period.
